(19) United States
(12) Patent Application Publication
(10) Pub. No.: US 2026/0023147 A1
(43) Pub. Date: Jan. 22, 2026

(54) RELATIVE LOCALIZATION METHOD AND SYSTEM

(71) Applicant: Nanyang Technological University, Singapore (SG)

(72) Inventors: Guoqiang HU, Singapore (SG); Jinxin LIU, Singapore (SG)

(21) Appl. No.: 18/998,391

(22) PCT Filed: Jul. 25, 2023
(86) PCT No.: PCT/SG2023/050521

§ 371 Date: Jan. 24, 2025

(30) Foreign Application Priority Data
Jul. 25, 2022 (SG) 10202250565F
May 3, 2023 (SG) 10202301238S

(51) Int. Cl. G01S 1/44; G01S 1/04; G01S 3/58; G01S 5/02; H04W 4/02

(52) U.S. Cl. CPC G01S 1/44; G01S 1/042; G01S 3/58; G01S 5/0289; H04W 4/027

(57) ABSTRACT

A method of estimating a relative position of a first robot with respect to a second robot at a current timestamp, wherein a first ultra-wideband (UWB) tag is installed on the first robot, the first UWB tag being a rotating tag configured to move in a circular path about a centre of rotation on the first robot, wherein a second UWB tag is installed on the second robot, the method comprising: receiving an estimate of the relative position of the first robot with respect to the second robot calculated at an earlier timestamp; obtaining rotating tag offset values of the first UWB tag with respect to the first robot at the earlier timestamp and at the current timestamp; obtaining a velocity value of the first robot at the earlier timestamp; obtaining a velocity value of the second robot at the earlier timestamp; obtaining distance values between the first UWB tag and the second UWB tag at the earlier timestamp and at the current timestamp; and calculating the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

### TECHNICAL FIELD

The present disclosure relates to a relative localization method and system, particularly to a range-based distributed localization method and system for multiple robots relying on onboard rotating ultra-wideband tags without external localization anchors.

### BACKGROUND

Multi-robot systems have emerged as alternatives and enhancements to single robot systems deployed in the military, logistics, and rescue. The determination of relative locations can be divided into two traditional approaches: anchor-based relative localization method and on-board relative localization method.

The first shortcoming of anchor-based localization methods is the limited range of location services offered. The second shortcoming of anchor-based localization methods is the need for a central node to solve all robots' data related to localization. The third shortcoming of anchor-based localization methods is the requirement for initial calibration.

Depending on the type of onboard sensors relied on, there are different implementations of on-board relative localization methods. Light Detection and Ranging (LiDAR) is often used as an on-board localization sensor. Marker-based relative localization methods have been widely used, but the effective distance is often short due to the limitation of marker size. Also, it is tough to track multiple targets due to the limited field of view.

Some range based relative location estimation methods have been developed. However, these methods often require multiple ultra-wideband (UWB) tags to be mounted on each robot, which increases the cost of the system. Moreover, the effective localization distance for small robots can be noticeably short.

It is thus desired to address or ameliorate one or more disadvantages or limitations associated with the prior art, or to at least provide a useful alternative.

### SUMMARY

According to a first aspect, there is provided a method of estimating a relative position of a first robot with respect to a second robot at a current timestamp, wherein a first ultra-wideband (UWB) tag is installed on the first robot, the first UWB tag being a rotating tag configured to move in a circular path about a centre of rotation on the first robot, the second robot having a second UWB tag installed thereon, the method comprising:
receiving an estimate of the relative position of the first robot with respect to the second robot calculated at an earlier timestamp;
obtaining rotating tag offset values of the first UWB tag with respect to the first robot at the earlier timestamp and at the current timestamp;
obtaining a velocity value of the first robot at the earlier timestamp;
obtaining a velocity value of the second robot at the earlier timestamp;
obtaining distance values between the first UWB tag and the second UWB tag at the earlier timestamp and at the current timestamp; and
calculating the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

The second UWB tag may be immovably fixed to the second robot, wherein the first robot is configured to transmit to the second robot the velocity value of the first robot and the rotating tag offset value of the first UWB tag with respect to the first robot, wherein the second robot is configured to transmit to the first robot the velocity value of the second robot.

Calculating the relative position of the first robot with respect to the second robot at the current timestamp may comprise:
calculating a relative position of the first UWB tag with respect to the second robot at the earlier timestamp based on the estimate of the relative position of the first robot with respect to the second robot at the earlier timestamp and the rotating tag offset value of the first UWB tag with respect to the first robot at the earlier timestamp;
calculating a relative velocity value between the first robot and the second robot at the earlier timestamp based on the velocity value of the first robot at the earlier timestamp and the velocity value of the second robot at the earlier timestamp;
calculating a relative rotation velocity value of the first UWB tag with respect to the first robot at the earlier timestamp according to the rotating tag offset value of the first UWB tag with respect to the first robot at the earlier timestamp and the current timestamp;
calculating a relative displacement value of the first UWB tag with respect to the second robot at the earlier timestamp according to: the relative velocity value between the first robot and the second robot at the earlier timestamp and the relative rotation velocity value of the first UWB tag with respect to the first robot at the earlier timestamp; and
updating the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second robot at the earlier timestamp.

Updating the relative position of the first robot with respect to the second robot at the current timestamp may comprise:
updating an estimation error at the current timestamp according to: the distance values between the first UWB tag and the second UWB tag at the earlier timestamp and at the current timestamp, the relative displacement value of the first UWB tag with respect to the second robot at the earlier timestamp, and the calculated relative location of the first UWB tag with respect to the second robot at the earlier timestamp; and
calculating the relative position of the first robot with respect to the second robot at the current timestamp according to: the estimation error at the current timestamp, the relative displacement value of the first UWB tag with respect to the second robot at the earlier timestamp, and the relative velocity value between the first robot and the second robot at the earlier timestamp.

The second UWB tag may be a rotating tag configured to move in a circular path about a centre of rotation on the second robot, the method further comprising:
obtaining rotating tag offset values of the second UWB tag with respect to the second robot at the earlier timestamp and at the current timestamp, respectively;
wherein calculating the relative position of the first robot with respect to the second robot at the current timestamp is further according to the rotating tag offset value of the second UWB tag with respect to the second robot.

The first robot may be configured to transmit to the second robot the velocity value of the first robot and the rotating tag offset value of the first UWB tag with respect to the first robot, wherein the second robot is configured to transmit to the first robot the velocity value of the second robot and the rotating tag offset value of the second UWB tag with respect to the second robot.

Calculating the relative position of the first robot with respect to the second robot at the current timestamp may comprise:
calculating a relative location of the first UWB tag with respect to the second UWB tag at the earlier timestamp according to: the estimate of the relative position of the first robot with respect to the second robot at the earlier timestamp, the rotating tag offset value of the first UWB tag with respect to the first robot at the earlier timestamp, and the rotating tag offset value of the second UWB tag with respect to the second robot at the earlier timestamp;
calculating a relative velocity value between the first robot and the second robot at the earlier timestamp based on the velocity value of the first robot at the earlier timestamp and the velocity value of the second robot at the earlier timestamp;
calculating a relative rotation velocity value of the first UWB tag with respect to the first robot at the earlier timestamp according to: the rotating tag offset values of the first UWB tag with respect to the first robot at the earlier timestamp and at the current timestamp;
calculating a relative rotation velocity value of the second UWB tag with respect to the second robot at the earlier timestamp according to: the rotating tag offset values of the second UWB tag with respect to the second robot at the earlier timestamp and at the current timestamp;
calculating a relative displacement value of the first UWB tag with respect to the second UWB tag at the earlier timestamp according to: the relative velocity value between the first robot and the second robot at the earlier timestamp, the relative rotation velocity value of the first UWB tag with respect to the first robot at the earlier timestamp, and the relative rotation velocity value of the second UWB tag with respect to the second robot at the earlier timestamp;
updating the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second UWB tag at the earlier timestamp.

Updating the relative position of the first robot with respect to the second robot at the current timestamp may comprise:
updating estimation error at the current timestamp according to the distance values between the first UWB tag and the second UWB tag at the earlier timestamp and at the current timestamp, the relative displacement value of the first UWB tag with respect to the second UWB tag at the earlier timestamp, and the estimate of the relative position of the first UWB tag with respect to the second UWB tag at the earlier timestamp; and
generating the relative position of the first robot with respect to the second robot at the current timestamp according to: the estimation error at the current timestamp, the relative location of the first UWB tag with respect to the second UWB tag at the earlier timestamp, the relative velocity value between the first robot and the second robot at the earlier timestamp, and the relative displacement value of the first UWB tag with respect to the second UWB tag at the earlier timestamp.

The method may further comprise estimating a relative position of the second robot with respect to a third robot according to the estimate of the relative position of the first robot with respect to the second robot and an estimate of the relative position of the first robot with respect to the third robot, the third robot having a UWB tag installed thereon.

The second robot may be configured to transmit to the third robot the estimate of the relative position of the first robot with respect to the second robot, wherein the third robot is configured to transmit to the second robot the estimate of the relative position of the first robot with respect to the third robot.

According to a second aspect, there is provided a system for estimating a relative position of a first robot with respect to a second robot at a current timestamp, the first robot having a first ultra-wideband (UWB) tag installed thereon, the first UWB tag being a rotating tag configured to move in a circular path about a centre of rotation on the first robot, the second robot having a second UWB tag installed thereon, the system comprising:
a data processor;
a memory coupled with the data processor; and
a program stored in the memory, the program including instructions capable of being executed by the data processor,
   wherein the program is configured to:
receive an estimate of the relative position of the first robot with respect to the second robot calculated at an earlier timestamp;
obtain rotating tag offset values of the first UWB tag with respect to the first robot at the earlier timestamp and at the current timestamp;
obtain a velocity value of the first robot at the earlier timestamp;
obtain a velocity value of the second robot at the earlier timestamp;
obtain distance values between the first UWB tag and the second UWB tag at the earlier timestamp and at the current timestamp; and
calculate the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

According to a third aspect, there is provided a multi-robot system comprising:
a first robot having a first ultra-wideband (UWB) tag installed thereon, the first UWB tag being a rotating tag configured to move in a circular path about a centre of rotation on the first robot;
a second robot having a second UWB tag installed thereon;
a data processor;
a memory coupled with the data processor; and
a program stored in the memory, the program including instructions capable of being executed by the data processor, wherein the program is configured to estimate a relative position of a first robot with respect to a second robot at a current timestamp, the program being configured to:
   receive an estimate of the relative position of the first robot with respect to the second robot calculated at an earlier timestamp;
   obtain rotating tag offset values of the first UWB tag with respect to the first robot at the earlier timestamp and at the current timestamp;
   obtain a velocity value of the first robot at the earlier timestamp;
   obtain a velocity value of the second robot at the earlier timestamp;
   obtain distance values between the first UWB tag and the second UWB tag at the earlier timestamp and at the current timestamp; and
   calculate the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

A motor may be provided on the robot at the centre of rotation and the first UWB tag may be displaced at a fixed distance from the motor such that rotation of the motor moves the first UWB tag about the centre of rotation in a circular path.

The first UWB tag may be provided at a first end of a rod, the first end being a free end, and a second end of the rod is attached to the motor.

For both the second and third aspects, the second UWB tag may be immovably fixed to the second robot, wherein the first robot is configured to transmit to the second robot the velocity value of the first robot and the rotating tag offset value of the first UWB tag with respect to the first robot, wherein the second robot is configured to transmit to the first robot the velocity value of the second robot.

To calculate the relative position of the first robot with respect to the second robot at the current timestamp, the program may be configured to:
calculate a relative position of the first UWB tag with respect to the second robot at the earlier timestamp based on the estimate of the relative position of the first robot with respect to the second robot at the earlier timestamp and the rotating tag offset value of the first UWB tag with respect to the first robot at the earlier timestamp;
calculate a relative velocity value between the first robot and the second robot at the earlier timestamp based on the velocity value of the first robot at the earlier timestamp and the velocity value of the second robot at the earlier timestamp;
calculate a relative rotation velocity value of the first UWB tag with respect to the first robot at the earlier timestamp according to the rotating tag offset value of the first UWB tag with respect to the first robot at the earlier timestamp and the current timestamp;
calculate a relative displacement value of the first UWB tag with respect to the second robot at the earlier timestamp according to: the relative velocity value between the first robot and the second robot at the earlier timestamp and the relative rotation velocity value of the first UWB tag with respect to the first robot at the earlier timestamp; and
update the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second robot at the earlier timestamp.

To update the relative position of the first robot with respect to the second robot at the current timestamp, the program may be configured to:
update an estimation error at the current timestamp according to: the distance values between the first UWB tag and the second UWB tag at the earlier timestamp and at the current timestamp, the relative displacement value of the first UWB tag with respect to the second robot at the earlier timestamp, and the calculated relative location of the first UWB tag with respect to the second robot at the earlier timestamp; and
calculate the relative position of the first robot with respect to the second robot at the current timestamp according to: the estimation error at the current timestamp, the relative displacement value of the first UWB tag with respect to the second robot at the earlier timestamp, and the relative velocity value between the first robot and the second robot at the earlier timestamp.

The second UWB tag may be a rotating tag configured to move in a circular path about a centre of rotation on the second robot, wherein the program is further configured to:
obtain rotating tag offset values of the second UWB tag with respect to the second robot at the earlier timestamp and at the current timestamp, respectively; and
calculate the relative position of the first robot with respect to the second robot at the current timestamp according to the rotating tag offset value of the second UWB tag with respect to the second robot.

The first robot may be configured to transmit to the second robot the velocity value of the first robot and the rotating tag offset value of the first UWB tag with respect to the first robot, wherein the second robot is configured to transmit to the first robot the velocity value of the second robot and the rotating tag offset value of the second UWB tag with respect to the second robot.

To calculate the relative position of the first robot with respect to the second robot at the current timestamp, the program may be configured to:
calculate a relative location of the first UWB tag with respect to the second UWB tag at the earlier timestamp according to: the estimate of the relative position of the first robot with respect to the second robot at the earlier timestamp, the rotating tag offset value of the first UWB tag with respect to the first robot at the earlier timestamp, and the rotating tag offset value of the second UWB tag with respect to the second robot at the earlier timestamp;
calculate a relative velocity value between the first robot and the second robot at the earlier timestamp based on the velocity value of the first robot at the earlier timestamp and the velocity value of the second robot at the earlier timestamp;
calculate a relative rotation velocity value of the first UWB tag with respect to the first robot at the earlier timestamp according to: the rotating tag offset values of the first UWB tag with respect to the first robot at the earlier timestamp and at the current timestamp;
calculate a relative rotation velocity value of the second UWB tag with respect to the second robot at the earlier timestamp according to: the rotating tag offset values of the second UWB tag with respect to the second robot at the earlier timestamp and at the current timestamp;
calculate a relative displacement value of the first UWB tag with respect to the second UWB tag at the earlier timestamp according to: the relative velocity value between the first robot and the second robot at the earlier timestamp, the relative rotation velocity value of the first UWB tag with respect to the first robot at the earlier timestamp, and the relative rotation velocity value of the second UWB tag with respect to the second robot at the earlier timestamp;
update the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second UWB tag at the earlier timestamp.

To update the relative position of the first robot with respect to the second robot at the current timestamp, the program may be further configured to:
update estimation error at the current timestamp according to the distance values between the first UWB tag and the second UWB tag at the earlier timestamp and at the current timestamp, the relative displacement value of the first UWB tag with respect to the second UWB tag at the earlier timestamp, and the estimate of the relative position of the first UWB tag with respect to the second UWB tag at the earlier timestamp; and
generate the relative position of the first robot with respect to the second robot at the current timestamp according to: the estimation error at the current timestamp, the relative location of the first UWB tag with respect to the second UWB tag at the earlier timestamp, the relative velocity value between the first robot and the second robot at the earlier timestamp, and the relative displacement value of the first UWB tag with respect to the second UWB tag at the earlier timestamp.

The program may be further configured to estimate a relative position of the second robot with respect to a third robot according to: the estimate of the relative position of the first robot with respect to the second robot and an estimate of the relative position of the first robot with respect to the third robot, the third robot having a UWB tag installed thereon.

The second robot may be configured to transmit to the third robot the estimate of the relative position of the first robot with respect to the second robot, wherein the third robot is configured to transmit to the second robot the estimate of the relative position of the first robot with respect to the third robot.

### BRIEF DESCRIPTION OF THE DRAWINGS

Some embodiments of the present invention are hereinafter further described, by way of example only, with reference to the accompanying drawings, in which:

FIG. 1A is a schematic drawing of a rotating UWB tag that uses a servo motor;

FIG. 1B is a schematic drawing of the rotating UWB tag that uses a brushless motor;

FIG. 2A is a photograph of a prototype of a rotating UWB tag that uses a servo motor;

FIG. 2B is a photograph of a prototype of a rotating UWB tag that uses a brushless motor;

FIG. 2C is a photograph of a configuration of rotating tags with varying rod lengths;

FIG. 3 is a schematic drawing of an installation of a rotating UWB tag on a leader robot;

FIG. 4 is a schematic drawing of an installation of a fixed UWB tag on a follower robot;

FIG. 5A is a schematic drawing of a relative localization method between a leader and follower robots within one cluster based on a single distance measurement;

FIG. 5B is a schematic drawing of a relative localization method between leader robots of different clusters based on a single distance measurement;

FIG. 6 is a flowchart to illustrate details of required information exchange for relative localization between the leader and follower robots within one cluster;

FIG. 7 is a flowchart to illustrate details of how to calculate the relative location between a leader robot and follower robots within one cluster;

FIG. 8 is a flowchart to illustrate details of required information exchange for relative localization between leader robots of different clusters;

FIG. 9 is a flowchart to illustrate details of how to calculate the relative location between leader robots of different clusters;

FIG. 10A is a depiction of various rod lengths used in a simulation of the present method.

FIG. 10B shows simulation results to show the influence of rod length for the present method;

FIGS. 11A and 11B show simulation results to show the influence of forgetting factor for the present method;

FIGS. 11C and 11D show simulation results to show the influence of noise level for the present method;

FIGS. 12A and 12B show experiment results of the present method in a stationary case with a rotating tag using a servo motor;

FIGS. 13A and 13B show experiment results of the present method in a relative motion case with a rotating tag using a servo motor;

FIGS. 14A-1, 14A-2, 14B and 14C show comparative experiment results of the present method and multi-tag method;

FIG. 15 shows experimental robots used to test the present method in nine different scenarios.

FIG. 16 is a flowchart to illustrate details of required information exchange for relative localization between follower robots in a same cluster with a first leader robot.

FIG. 17 is a flowchart to illustrate details of how to calculate the relative location between follower robots; and

FIG. 18 shows a system comprising the program for processing methods shown in FIG. 7 and FIG. 9.

### DETAILED DESCRIPTION

Before introducing the proposed invention, the present disclosure first discusses the traditional anchor-based relative localization method and on-board relative localization method. Multi-robot systems have emerged as alternatives and enhancements to single robot systems deployed in the military, logistics, and rescue. Obtaining the relative locations between robots is usually critical to deploying multi-robot systems. The determination of relative locations can be divided into two traditional approaches. If a fixed anchor point exists in the system, it can be classified as the anchor-based relative localization method. If the system relies entirely on the robots' on-board sensors, it can be classified as the on-board relative localization method.

Anchor-based localization methods include the Global Positioning System (GPS), the motion capture system, the UWB with fixed anchor beacon, the global camera localization system, etc. These methods have been more widely used in real life; however, due to the need for anchors, such methods have shortcomings that are difficult to overcome.

The first shortcoming of anchor-based localization methods is the limited range of location services offered. GPS localization accuracy can be significantly affected or even unusable in tunnels, canyons, and indoors, while other anchor-based localization methods need to set up anchors in advance in the area where localization services are required and cannot provide relative localization services in unknown regions. Moreover, the area that can provide localization services is positively correlated with the number of anchors. The larger the area that needs to be provided, the higher the cost of the system.

The second shortcoming of anchor-based localization methods is the need for a central node to solve all robots' data related to localization. As the number of robots in the system scales up, the central node's computational and communication burdens increase rapidly. Moreover, the presence of central nodes runs counter to the idea of distributed systems where relative locations are often applied. Further, the presence of the central node poses a significant risk to the privacy of individual robots.

The third shortcoming of anchor-based localization methods is the requirement for initial calibration. Only calibrated anchors can provide valid information to the localization system. Even if only one anchor beacon is moved, the initial calibration process must be repeated.

The on-board relative localization method can be easily deployed on robots in a distributed manner because it does not rely on any external localization device. By eliminating the need for fixed anchors, on-board localization solutions often can provide relative localization services in unknown areas. Depending on the type of onboard sensors relied on, there are different implementations of on-board relative localization methods.

LiDAR is often used as an on-board localization sensor. However, LiDAR is often expensive. It is difficult to distinguish whether it is a target robot, or an obstacle based on the point cloud map returned by LiDAR. Depth cameras are also often used, but the effective distance of depth cameras is often noticeably short, and it is often difficult to obtain the depth of objects with small cross sections. Marker-based relative localization methods have been widely used, but the effective distance is often short due to the limitation of marker size. Also, it is tough to track multiple targets due to the limited field of view. Based on the sensors mentioned above, simultaneous localization and mapping (SLAM) techniques can also be used to obtain relative locations but often require maps to be constructed in advance.

Based on the distance data returned by the on-board UWB tags, some range based relative location estimation methods have been developed. However, these methods often require multiple UWB tags to be mounted on cach robot, which increases the cost of the system. Moreover, the effective distance of the localization service is often positively correlated with the distance between tags installed on the same robot, which means that the effective localization distance for small robots can be noticeably short.

To address the shortcomings of the above solutions, an on-board relative localization method is proposed in the present disclosure, and the method requires only one UWB tag per robot. In the present method, UWB tags that are installed on leader robots are rotated to move in a circular path about a centre of rotation based on a configuration of a mechanical structure provided to rotate each UWB tag, while UWB tags are fixedly installed on follower robots. Furthermore, the solution provides relative localization services regardless of whether the robots are in relative motion or stationary motion. In particular, the present disclosure relates to a relative localization method and system, particularly to a range-based distributed localization method and system for multiple robots in a two-dimensional plane, relying on onboard rotating UWB tags without external localization anchors. The proposed relative localization method aims to overcome the shortcomings of the limited field of view, remove the need for the central node, overcome the need to deploy external localization anchors, as well as eliminate the need for initial calibration. In particular, the proposed relative localization method can be deployed in global navigation satellite system (GNSS)-denied environments, and it is able to provide localization services no matter whether the robots are stationery or in relative motion.

In particular, the proposed method is a range-based relative localization method in which each robot is provided with the following: only one UWB tag to supply a single distance measurement for measuring a relative distance between other UWB tags, a Wi-Fi module to supply communication services between robots, an electronic compass to provide a consistent coordinate frame, and an odometry to provide the robot's velocity. In the present disclosure, there is provided a mechanical structure configuration for the rotating UWB tag. With only one leader robot being provided with a rotating UWB tag and the remaining follower robots being provided with only one fixed UWB tag each, the robots can locate each other in a distributed manner. The present disclosure further provides a hierarchical architecture for a multi-robot system, in which the system is composed of multiple clusters. Each cluster consists of a leader robot and an arbitrary number of follower robots. Compared to the single-leader robot structure, this multi-cluster architecture enhances the scalability of the entire multi-robot system.

One or more specific and alternative embodiments of the proposed invention will now be described with reference to the attached drawings. It shall be apparent to one skilled in the art, however, that this invention may be practiced without such specific details. Some of the details may not be described at length so as not to obscure the invention. For ease of reference, common reference numerals or series of numerals will be used throughout the figures when referring to the same or similar features common to the figures.

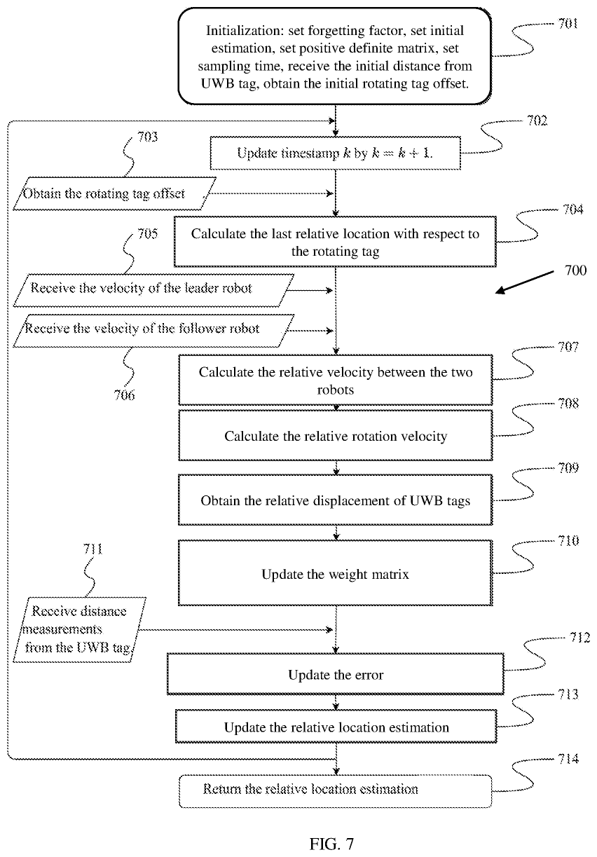

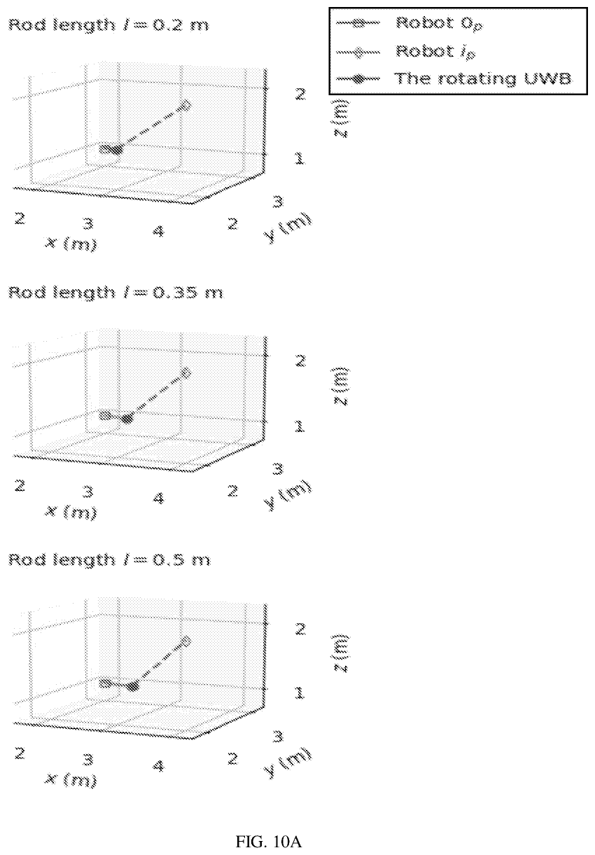

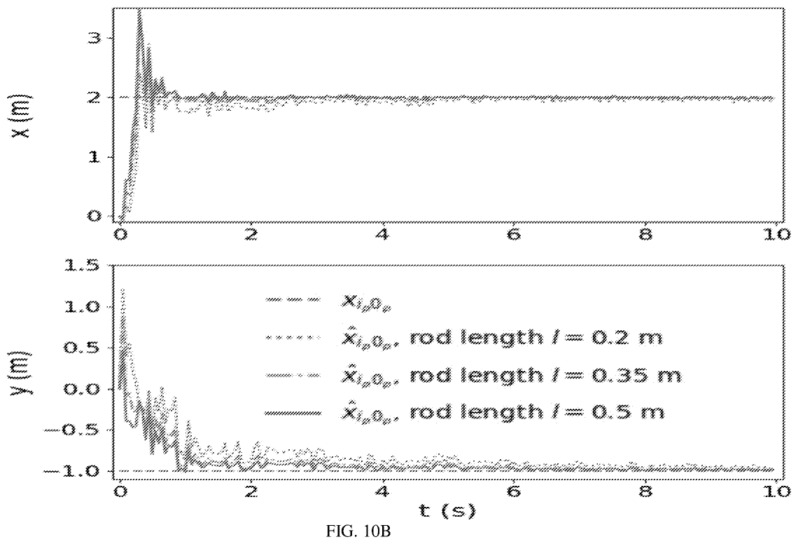

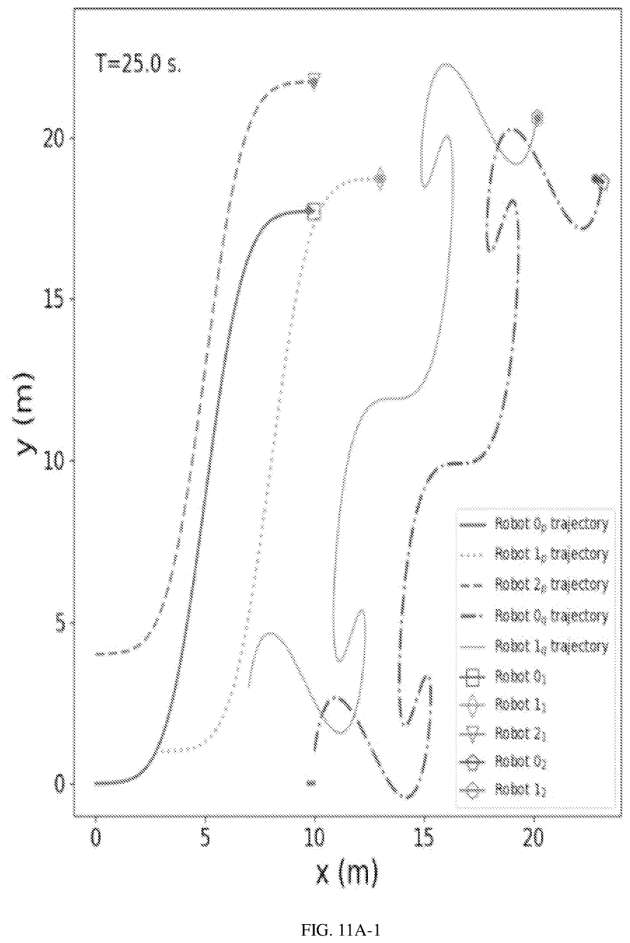

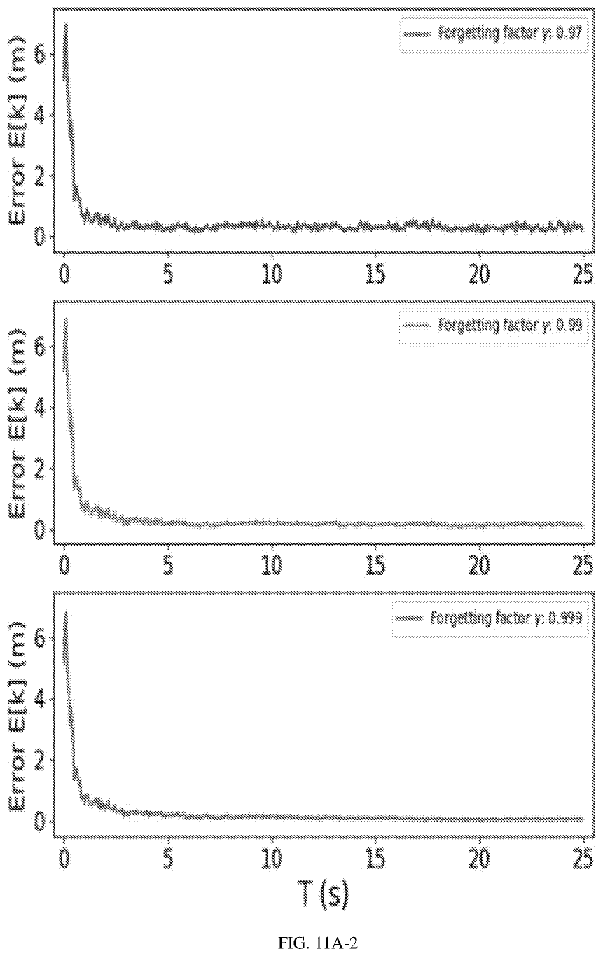

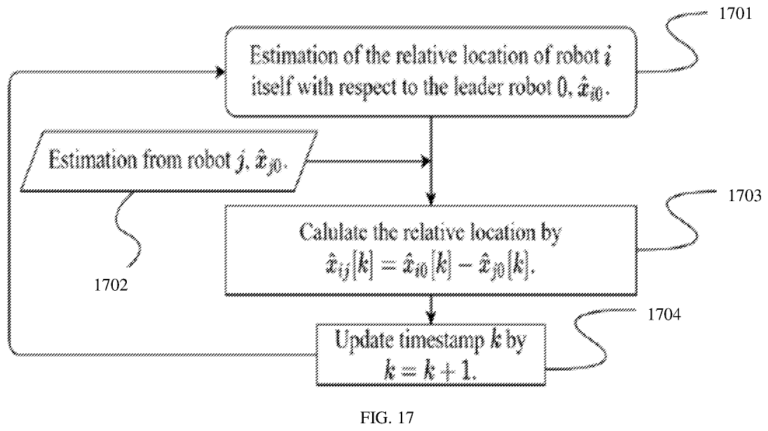

As will be discussed in detail, the present disclosure provides three distributed algorithms for relative location estimation. The first algorithm illustrated in FIG. 7 is used to estimate the relative locations between the leader robot and the follower robot within the same cluster. The second algorithm illustrated in FIG. 10 is used to estimate the relative locations between the leader robots of different cluster. The third algorithm illustrated in FIG. 17 is used to estimate the relative locations between the follower robots. The above three algorithms can be deployed in a distributed manner in the multi-robot system.

The present disclosure now illustrates said algorithms. On-board methods based on the single distance measurement are proposed to address the mentioned problems in the relative localization of robots. In said methods, one random robot in the multi-robot system is selected to install the designed rotating UWB tag and is called the leader robot. The other robots are called the follower robots and are installed with fixed UWB tags.

For any robot i in cluster p, the dynamics can be described as xᵢ_{ₚ}[k]=xᵢ_{ₚ}[k−1]+vᵢ_{ₚ}[k−1]ΔT, where xᵢ_{ₚ}[k]∈ [symbol] ² denotes the absolute location of robot iₚ in the world coordinate frame [symbol] _{w} at timestamp k; vᵢ_{ₚ}[k]∈ [symbol] ² denotes the absolute velocity of robot iₚ in the world coordinate frame [symbol] _{w} at timestamp k, ΔT is the sampling time between the timestamps k and k−1. The relative location of robot iₚ with respect to robot j_{q} in the frame [symbol] _{w} can be represented by

$${x}_{{i}_{p {j}_{q}}} [ k ] = {x}_{{i}_{p}} [ k ] - {x}_{{j}_{q}} [ k ] .$$

Similarly, the relative velocity can be denoted by vᵢ_{ₚ}_{^{j}}_{_{q}}[k]=vᵢ_{ₚ}[k]−vⱼ_{_{q}}[k]. The goal of this method is to give \hat{x}ᵢ_{ₚ}_{^{j}}_{_{q}}[k] by algorithms such that lim_{k→∞}∥\hat{x}ᵢ_{ₚ}_{^{j}}_{_{q}}[k]−xᵢ_{ₚ}_{^{j}}_{_{q}}[k]∥=0 holds.

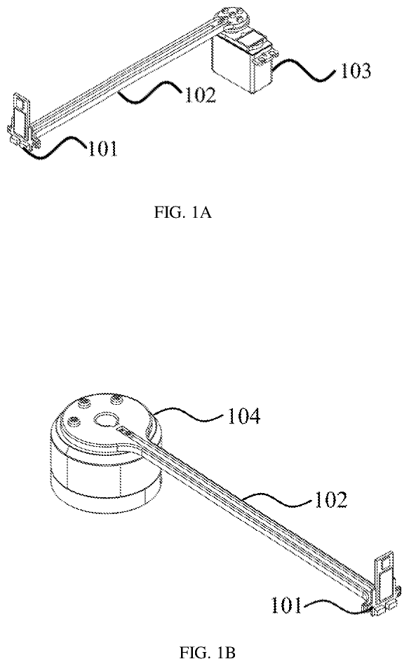

FIG. 1A shows an exemplary embodiment of a rotating UWB tag 101 that uses a servo motor 103 to rotate the tag. The UWB tag 101 and servo motor 103 are connected by a rod 102 having a length l, wherein the UWB tag 101 is provided at a first end of the rod 102. the first end being a free end, and a second end of the rod 102 is connected to the servo motor 103. This mechanical structure allows the UWB tag 101 to rotate around the servo motor 103 in a circular path. FIG. 1B shows another similar configuration for a rotating tag 101. In comparison to the configuration in FIG. 1A, the configuration in FIG. 1B utilizes a brushless motor 104 instead of a servo motor 103. A brushless motor is preferred as it can provide more accurate angle feedback and, in conjunction with a slip ring, it can rotate indefinitely in the same direction. However, it should be noted that any rotating motor that can provide angle feedback can be used in the mechanical structure of the rotating tag 101. Furthermore, in alternative embodiments, the rotating tag may be provided at the edge of a circular disc where a geometrical centre of the disc is attached to the motor so that rotation of the disc by the motor moves the tag in a circular path. Appreciably, any mechanical structure may be envisaged that displaces the rotating tag by a fixed distance from the centre of rotation where the motor is installed such that rotation of the motor moves the rotating tag in a circular path about the centre of rotation.

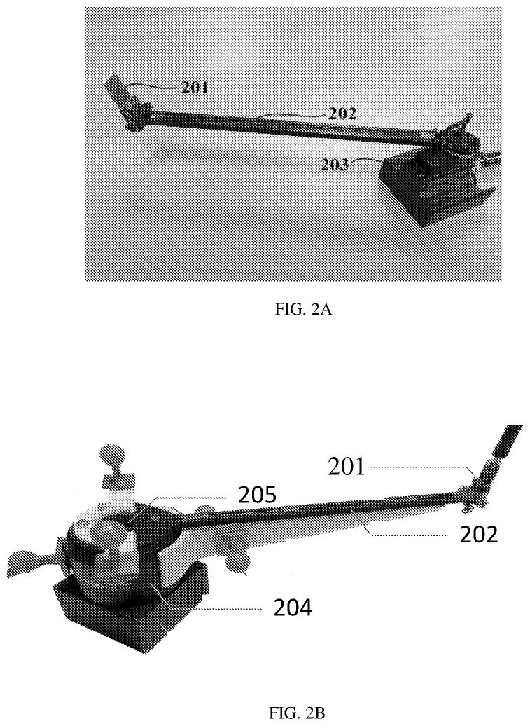

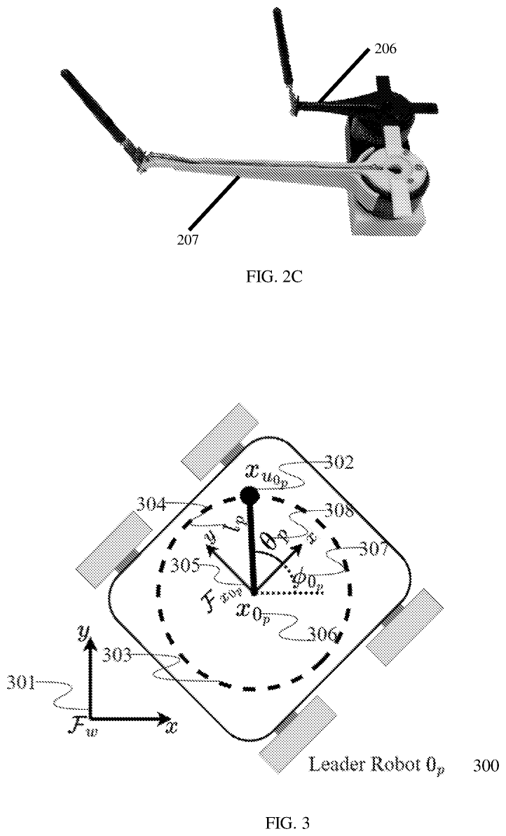

FIG. 2A depicts the prototype of the rotating UWB tag 201. The symbols 201. 202, and 203 correspond to symbols 101, 102, and 103 in the schematic drawing FIG. 1A, respectively. The length of rod 202 is set to 0.2 m, but it may also be any other length. FIG. 2B illustrates an alternative configuration for the rotating UWB tag 201. While FIG. 2A utilizes a servo motor 203, the configuration in FIG. 2B uses a brushless motor 204 and introduces a slip ring 205 to enable the tag 201 to move in a circular path continuously in one direction without getting tangled up in wires. FIG. 2C depicts two configurations with different rod lengths. In particular, rod 207 has a rod length of 0.25 m and the other rod 206 has a rod length of 0.1 m. It will be appreciated that the length of the rod connecting the motor and the UWB tag can be any length, not limited to the aforementioned lengths, wherein that the length of the rod is taken to be the distance by which the rotating tag is displaced from the centre of rotation.

FIG. 3 shows a rotating UWB tag 302 installed on a leader robot 300 in cluster p., wherein the UWB tag 302 is provided at the first end of a rotating rod 304, the first end being a free end, and the second end of the rod 304 is attached to a motor mounted on the leader robot 300. [symbol] _{w}, 301 refers to a world coordinate frame wherein based on data returned by the electronic compass provided on each robot, all robots can share the same world coordinate system [symbol] _{w}, 301. The symbol xᵤ_{₀} refers to the absolute location of the rotating UWB tag 302 in coordinate system [symbol] _{w}. The symbol x₀_{ₚ} refers to the centre of rotation 306 of the UWB tag 302 on the leader robot 300, which is preferably (although not necessarily) located at a geometric centre (also referred to as base link centre) of the leader robot 300. Appreciably, the centre of rotation 306 of the UWB tag 306 is where the second end of the rod 304 is attached to the motor. For convenience, the location of the centre of rotation 306 is considered the absolution location of the robot 300. As the rotating rod 304 rotates, the UWB tag 302 moves along a circular path 303 having a radius lₚ, 304 about the centre of rotation 306. The symbol

$${ℱ}_{{x}_{{0}_{p}}} ,$$

305 referes to the centre of rotation coordinate frame of the leader robot 0ₚ. The angle ϕ₀_{ₚ}, 307 between an x-axis of the centre of rotation coordinate frame

$${ℱ}_{{x}_{{0}_{p}}} ,$$

305 of the leader robot 300 and an x-axis of the world coordinate system [symbol] _{w}. 301 can be obtained by the electronic compass of the robot 300. The coordinate rotation matrix from the frame

$${ℱ}_{{x}_{{0}_{p}}}$$

to frame [symbol] _{w} can be obtained by

$${ℛ}_{{x}_{{0}_{p}}}^{w} = [ \begin{matrix}cos & {ϕ}_{{0}_{p}} & - sin {ϕ}_{{0}_{p}} \\ sin & {ϕ}_{{0}_{p}} & cos {ϕ}_{{0}_{p}}\end{matrix} ] .$$

The angle θₚ, 308 between the x-axis of

$${ℱ}_{{x}_{{0}_{p}}}$$

and the rotating rod 304 can be obtained by data from the servo motor. Let ρₚ denote the rotating offset value of the rotating UWB tag 302 with respect to the centre of rotation 306, and let θₚ, 308 represent the rotating angle in the frame

$${ℱ}_{{x}_{0 p}} .$$

Thus, the relationship between the absolute location of the rotating tag 302 and the absolute location 306 of the leader robot 300 can be obtained by

$${x}_{{u}_{0 p}} [ k ] = {x}_{{0}_{p}} [ k ] + {ρ}_{p} [ k ] ,$$

where the offset can be calculated by

$${ρ}_{p} [ k ] = {{ℛ}_{{x}_{0 p}}^{w} [ k ] [ {l}_{p} cos θ [ k ] , {l}_{p} sin θ [ k ] ]}^{T} .$$

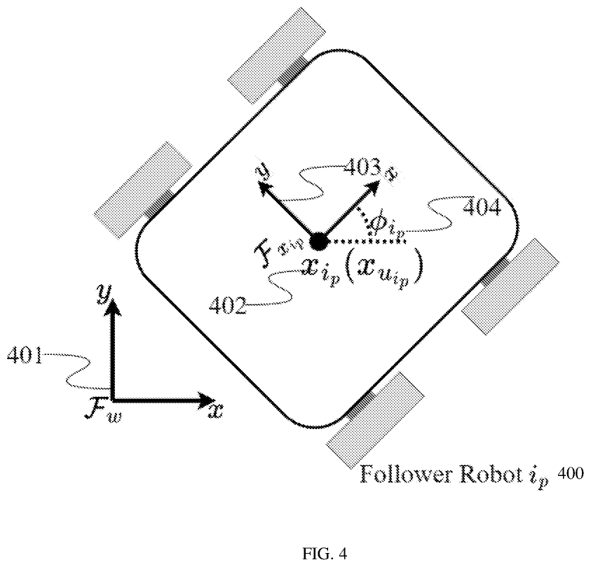

FIG. 4 depicts the schematic drawing of the installation of the fixed UWB tag on the follower robot iₚ, 400. Without loss of generality, any one follower robot iₚ, 400 is chosen as an example. The symbol [symbol] _{w}, 401 denotes the world coordinate frame shared with other robots. Reference numeral 402 denotes the fixed location where UWB tag is mounted. For convenience, the fixed location 402 of the UWB tag is considered as the absolute position of the robot iₚ, 400, i.e.,

$${x}_{{i}_{p}} = {x}_{{u}_{{i}_{p}}} .$$

Preferably, this absolute position is at the geometric centre of the robot iₚ, 400 which can be referred to as the base link centre of the robot iₚ, 400. The symbol

$${ℱ}_{{x}_{{i}_{p}}} ,$$

403 represents the fixed UWB tag frame. The rotation matrix

$${ℛ}_{{x}_{ip}}^{w}$$

from [symbol] ₓ_{ᵢₚ} to [symbol] _{w} can be obtained from ϕᵢ_{ₚ}, 404, which is the angle between an x-axis of the fixed UWB tag frame

$${ℱ}_{{x}_{{i}_{p}}} ,$$

403 and an x-axis of the world coordinate frame [symbol] _{w}, 401, where

$${ℛ}_{{x}_{{i}_{p}}}^{w} = [ \begin{matrix}cos & {ϕ}_{{i}_{p}} & - sin {ϕ}_{{i}_{p}} \\ sin & {ϕ}_{{i}_{p}} & cos {ϕ}_{{i}_{p}}\end{matrix} ] .$$

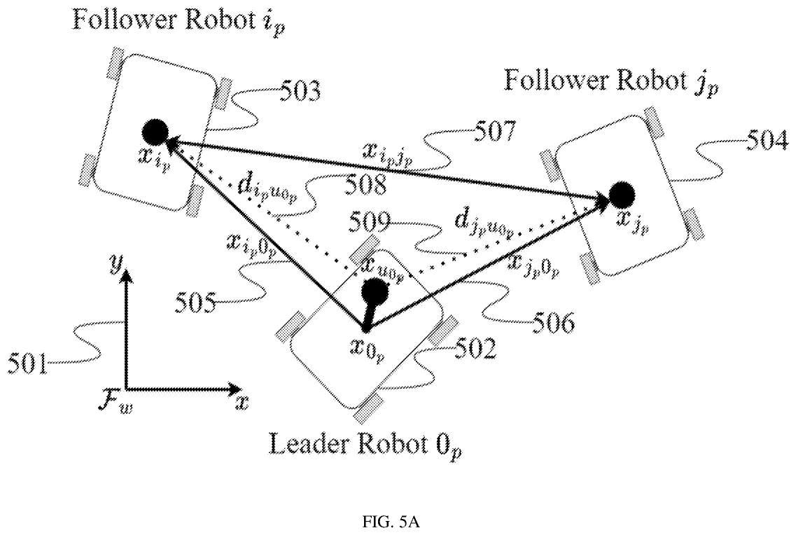

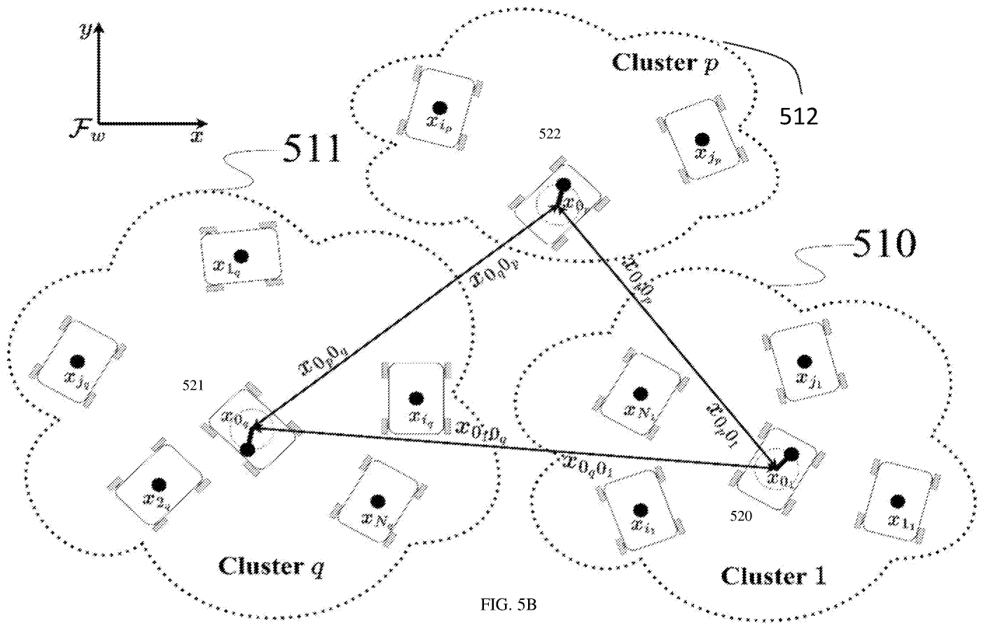

FIG. 5A illustrates a relative localization between a leader robot 500 and follower robots 510 and 520 in one cluster. The symbol [symbol] _{w}, 501 refers to the world frame. Robots equipped with the rotating UWB tag are called leader robots 0ₚ, 502, and the remaining robots equipped with fixed UWB tags are called follower robots iₚ, 503 and jₚ, 504. For the leader robot 0ₚ, 502, the relative locations of all follower robots, i.e., xᵢ_{ₚ}_{⁰}_{ₚ}, 502 and xⱼ_{ₚ}_{⁰}_{ₚ}, 506 need to be obtained. As will be discussed in detail, the first algorithm illustrated in FIG. 7 is configured to estimate the relative location between leader robot 0ₚ, 502 and the follower robot iₚ, 503.

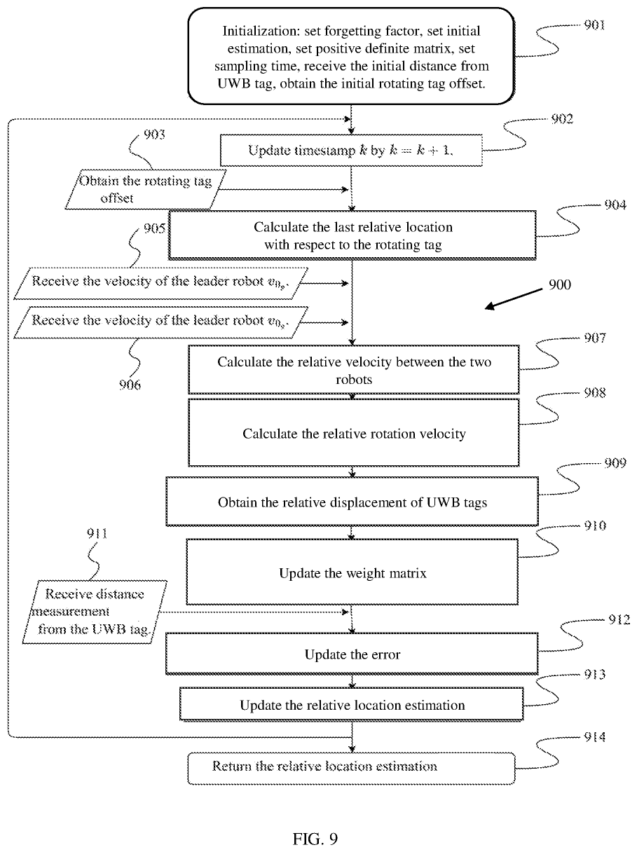

FIG. 5B depicts a relative localization between leader robots of different clusters. Symbols 510, 511, and 512 represent three distinct robot clusters, each of which has a leader robot 520, 521 and 522, respectively equipped with a rotating UWB tag. In addition, the second algorithm illustrated in FIG. 9 is designed to obtain the relative location estimation between two clusters leader robots. Thus, relative location of any two robots can be obtained by

$${\hat{x}}_{{i}_{p {j}_{q}}} = {\hat{x}}_{{i}_{p} {0}_{p}} + {\hat{x}}_{{0}_{p} {0}_{q}} + {\hat{x}}_{{0}_{q} {j}_{q}} .$$

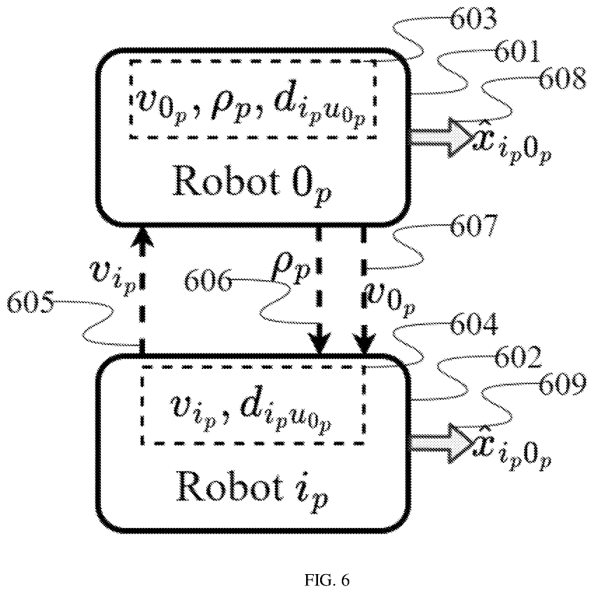

FIG. 6 shows the flowchart to illustrate details of the required information exchange for relative localization between the leader and follower robots. As shown in FIG. 6, the leader robot 0ₚ, 601 is configured to transmit to the follow robot iₚ, 602 the velocity value v₀_{ₚ}, 607 of the leader robot and the rotating tag offset value ρₚ, 606 of the UWB tag with respect to the leader robot 0ₚ, wherein the follower robot iₚ is configured to transmit to the leader robot 0ₚ the velocity value vᵢ_{ₚ}, 605 of the follower robot. To describe the relative localization method between the leader robot and the follower robots within the same cluster, the relative localization between the leader robot 0ₚ and follower robot iₚ is used as an example. For leader robot 0ₚ 601, the data that can be obtained from the on-board sensors are 603, including v₀_{ₚ}, ρₚ and dipuop where dipuop refers to the distance value between the UWB tag of the leader robot 0ₚ and the follower robot iₚ. After receiving the velocity vᵢ_{ₚ}, 605 from the follower robot iₚ, 602 (for example via Wi-Fi), the leader robot 0ₚ, 601 can give the relative location estimation \hat{x}ᵢ_{ₚ}_{⁰}_{ₚ} 608 by deploying the first algorithm 700 shown in FIG. 7. For follower robot iₚ 602, the data 604 that can be obtained from the on-board sensors include v₀_{ₚ}, 607 and dᵢ_{_{g}}_{^{u}}_{₀}. After receiving the offset ρₚ, 606 and the velocity v₀_{ₚ}, 607 from the leader robot 0ₚ, 601 via Wi-Fi, the follower robot iₚ, 602 can also give its relative location estimation \hat{x}ᵢ_{ₚ}_{⁰}_{ₚ} 609 by deploying the first algorithm 700.

FIG. 7 depicts the flowchart to illustrate details of how to calculate the relative location between the leader and follower robots within the same cluster p. In general, FIG. 7 relates to a method 700 of estimating relative position of a first robot (i.e., in this scenario a leader robot) with respect to a second robot (i.e., in this scenario a follower robot) at a current timestamp (i.e., time stamp k+1), wherein a first UWB tag or rotating tag is installed on the first robot and moves in a circular path about a centre of rotation on the first robot and a second UWB tag is fixedly installed on the second robot, the method 700 comprising:
Step 701: receiving an estimate of the relative position of the first robot with respect to the second robot calculated at an earlier timestamp (i.e., time stamp k);
Step 703: obtaining rotating tag offset values of the first UWB tag with respect to the first robot at the earlier timestamp and the current timestamp;
Step 705: obtaining a velocity value of the first robot at the earlier timestamp;
Step 706: obtaining a velocity value of the second robot at the earlier timestamp;
Step 711: obtaining distance values between the first UWB tag and the second UWB tag at the earlier timestamp and at the current timestamp (It will be appreciated that in the present disclosure, when the second robot is immovably fixed to a second UWB tag, the distance value between the first UWB tag and the second UWB tag is regarded same as the distance value between the first UWB tag and the second robot.); and
calculating the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity value of the first robot at the earlier timestamp, the velocity value of the second robot at the earlier timestamp, and the distance values between the first UWB tag and the second robot at the earlier timestamp and at the current timestamp.

In some embodiments for example as shown in FIG. 7, calculating the relative position of the first robot with respect to the second robot at the current timestamp comprises:
Step 704: calculating a relative position of the first UWB tag with respect to the second robot at the earlier timestamp based on the estimate of the relative position of the first robot with respect to the second robot at the earlier timestamp and the rotating tag offset value of the first UWB tag with respect to the first robot at the earlier timestamp;
Step 707: calculating a relative velocity value between the first robot and the second robot at the earlier timestamp based on the velocity value of the first robot at the earlier timestamp and the velocity value of the second robot at the earlier timestamp;
Step 708: calculating a relative rotation velocity value of the first UWB tag with respect to the first robot at the earlier timestamp according to the rotating tag offset value of the first UWB tag with respect to the first robot at the earlier timestamp and the current timestamp;
Step 709: calculating a relative displacement value of the first UWB tag with respect to the second robot at the earlier timestamp according to the relative velocity value between the first robot and the second robot at the earlier timestamp and the relative rotation velocity value of the first UWB tag with respect to the first robot at the earlier timestamp; and
updating the relative position of the first robot with respect to the second robot at the current timestamp according to the estimate of the relative position of the first robot with respect to the second robot at the earlier timestamp, the relative velocity value between the first robot and the second robot at the earlier timestamp, the distance value between the first UWB tag and the second robot at the earlier timestamp and the current timestamp, and the relative displacement value of the first UWB tag with respect to the second robot at the earlier timestamp.

In particular, updating the relative position of the first robot with respect to the second robot at the current timestamp comprises:
Step 712: updating an estimation error at the current timestamp according to said distance value between the first UWB tag and the second robot at the earlier timestamp and at the current timestamp, the relative displacement value of the first UWB tag with respect to the second robot at the earlier timestamp, and the calculated relative location of the first UWB tag with respect to the second robot at the earlier timestamp; and
Step 713: calculating the relative position of the first robot with respect to the second robot at the current timestamp according to: the estimation error at the current timestamp, the relative displacement value of the first UWB tag with respect to the second robot at the earlier timestamp, and the relative velocity value between the first robot and the second robot at the earlier timestamp.

To be more specific, the algorithm 700 can be deployed on the leader robot 0ₚ to estimate the relative location of the follower robot iₚ, or on the follower robot iₚ to estimate the relative location of the leader robot 0ₚ.

In step 701, the initialization of algorithm 700 is illustrated, the initial estimation \hat{x}ᵢ_{ₚ}_{⁰}_{ₚ}[0], the forgetting factor γ∈(0,1), the positive definite weight matrix P[0], and the sampling time ΔT need to be set. Moreover, the initial offset ρₚ[0] and initial distance

$${d}_{{i}_{p} {u}_{{0}_{p}}} [ 0 ]$$

should be received from sensors. Then, the serial number of the timestamp is added in 702. In 703, the offset ρₚ[k] should be obtained from sensors.

Based on the offset at the previous timestamp, the estimation of robot iₚ with respect to the rotating tag can be obtained according to the equation (1) in 704, that is:

$${\hat{x}}_{{u}_{{i}_{p}} {u}_{{0}_{p}}} [ k - 1 ] = {\hat{x}}_{{i}_{p} {0}_{p}} [ k - 1 ] - {ρ}_{p} [ k - 1 ] \qquad ( 1 )$$

In steps 705 and 706, the velocities of the leader robot 0ₚ and the follower robot iₚ are obtained separately.

Then, the relative velocity is obtained in step 707 according to equation (2), and the relative rotating velocity is obtained according to equation (3) at step 708, that is:

$${v}_{{i}_{p} {0}_{p}} [ k - 1 ] = {v}_{{i}_{p}} [ k - 1 ] - {v}_{{0}_{p}} [ k - 1 ] \qquad ( 2 )$$

$${v}_{{ρ}_{p}} [ k - 1 ] = \frac{1}{Δ T} ( {ρ}_{p} [ k ] - {ρ}_{p} [ k - 1 ] ) \qquad ( 3 )$$

Thus, the relative displacement of UWB tags between the last timestamp and now,

$${η}_{{u}_{{i}_{p}} {u}_{{0}_{p}}} [ k - 1 ] ,$$

can be obtained by the equation (4) in step 709.

$${η}_{{u}_{{i}_{p}} {u}_{{0}_{p}}} [ k - 1 ] = {v}_{{i}_{p} {0}_{p}} [ k - 1 ] Δ T - {v}_{{ρ}_{p}} [ k - 1 ] Δ T \qquad ( 4 )$$

By the equation (5) in step 710, the weight matrix is updated.

$$P [ k ] = \frac{1}{γ} ( I - \frac{P [ k - 1 ] {η}_{{u}_{ip} {u}_{{0}_{p}}} [ k - 1 ] {η}_{{u}_{{i}_{p}} {u}_{{0}_{p}}}^{T} [ k - 1 ]}{γ + {η}_{{u}_{{i}_{p}} {u}_{{0}_{p}}}^{T} [ k - 1 ] P [ k - 1 ] {η}_{{u}_{{u}_{p}} {u}_{0 jp}} [ k - 1 ]} ) P [ k - 1 ] \qquad ( 5 )$$

After receiving the distance information from the UWB tag in 711, the estimation error ϵ[k] can be calculated in step 712 according to equation (6).

$$ϵ [ k ] = \frac{1}{2} ( {d}_{{i}_{p} {u}_{{0}_{p}}}^{2} [ k ] - {d}_{{i}_{p} {u}_{{0}_{p}}}^{2} [ k - 1 ] - {‖ {η}_{{u}_{{i}_{p}} {u}_{{0}_{p}}} [ k - 1 ] ‖}^{2} ) - {η}_{{u}_{{i}_{p}} {u}_{0}}^{T} [ k - 1 ] {\hat{x}}_{{u}_{{i}_{p}} {u}_{{u}_{p}}} [ k - 1 ] \qquad ( 6 )$$

In step 713, the estimation of relative location between leader robot 0ₚ and follower robot iₚ can be calculated according to equation (7).

$${\hat{x}}_{{i}_{p} {0}_{p}} [ k ] = {\hat{x}}_{{i}_{p} {0}_{p}} [ k - 1 ] + {v}_{{i}_{p} {0}_{p}} [ k - 1 ] Δ T + P [ k ] {η}_{{u}_{{i}_{p}} {u}_{{p}_{p}}} [ k - 1 ] ϵ [ k ] \qquad ( 7 )$$

In step 714, the estimation is returned. It will be appreciated that the goal of this method is to give \hat{x}ᵢ_{ₚ}_{⁰}_{ₚ}[k] by algorithms such that lim_{k→∞}∥\hat{x}ᵢ_{ₚ}_{⁰}_{ₚ}[k]−xᵢ_{ₚ}_{⁰}_{ₚ}[k]∥=0 holds.

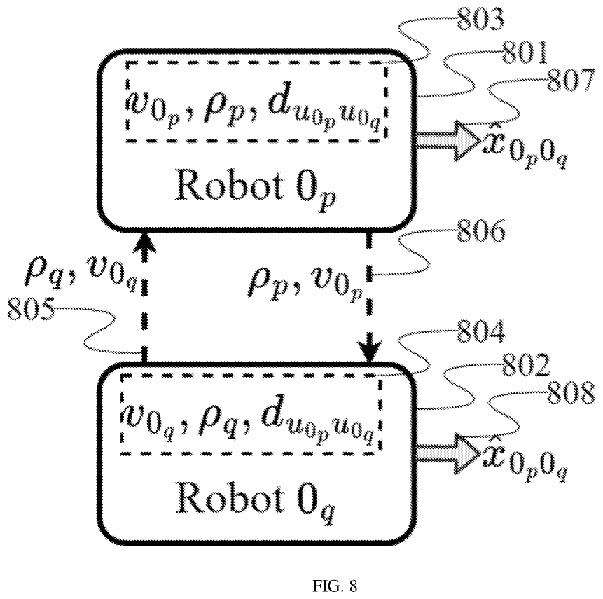

FIG. 8 depicts the flowchart to illustrate details of required information exchange for relative localization between leader robots of different clusters. As shown in FIG. 8, a first leader robot 0ₚ, 801 is configured to transmit to a second leader robot 0_{q}, 802 the velocity value v₀_{ₚ} of the first leader robot 0ₚ, 801 and the rotating tag offset value ρₚ of a first UWB tag with respect to the first leader robot 0ₚ, 801, wherein the first UWB tag is installed on the first leader robot 0ₚ, 801, and continuously about a centre of rotation on the first leader robot 0ₚ, 801. The second leader robot 0_{q}, 802 is configured to transmit to the first leader robot 0ₚ, 801 the velocity value vog of the second leader robot 0_{q}, 802 and the rotating tag offset value ρ_{q} of a second UWB tag respect to the second leader robot 0_{q}, 802, wherein the second UWB tag is installed on the second leader robot 0_{q}, 802 and moves in a circular path about a centre of rotation on the second leader robot 0_{q}, 802. To describe the relative localization method between the two leader robots 0ₚ, 801 and 0_{q}, 802, the relative localization between the leader robots 0ₚ, 801 and 0_{q}, 802 is used as an example. For first leader robot 0ₚ 801, based on v₀_{ₚ}, ρₚ, and

$${d}_{{u}_{{0}_{p}} {u}_{{0}_{q}}}$$

803 obtained by sensors and v₀_{_{q}}, ρ_{q} 805 obtained from second leader robot 0_{q} via Wi-Fi, the estimation \hat{x}₀_{ₚ}_{⁰}_{q} 807 can be obtained by the second algorithm 900 shown in FIG. 9. Similarly, for the second leader robot 0_{q} 802, the estimation \hat{x}₀_{ₚ}_{⁰}_{_{q}} 808 can also be obtained by the second algorithm 900 shown in FIG. 9.

FIG. 9 depicts the flowchart to illustrate details of how to calculate the relative location between leader robots of different clusters. In general, FIG. 9 relates to a method 900 of estimating relative position of a first robot (i.e., in this scenario a first leader robot 0ₚ) with respect to a second robot (i.e., in this scenario a second leader robot in another cluster 0_{q}) at a current timestamp (i.e., time stamp k+1), wherein a first ultra-wideband (UWB) tag or rotating tag is installed on the first robot and configured to rotate or move in a circular path about a centre of rotation on the first robot, and the second robot comprises a second UWB tag installed on the second robot and configured to move in a circular path about a centre of rotation on the second robot, the method 900 comprising:
Step 901: receiving an estimate of the relative position of the first robot with respect to the second robot calculated at an earlier timestamp (i.e., time stamp k);
Step 903: obtaining rotating tag offset values of the first UWB tag with respect to the first robot at the earlier timestamp and at the current timestamp, respectively;
Step 905: obtaining a velocity value of the first robot at the earlier timestamp;
Step 906: obtaining a velocity value of the second robot at the earlier timestamp;
Step 911: obtaining distance value between the first UWB tag and the second UWB tag at the earlier timestamp and at the current timestamp; and
calculating the relative position of the first robot with respect to the second robot at the current timestamp according to the estimate of the relative position calculated at the earlier timestamp, the rotating tag offset value of the first UWB tag with respect to the first robot at the earlier timestamp and at the current timestamp, the velocity value of the first robot at the earlier timestamp, the velocity value of the second robot at the earlier timestamp, and the distance values between the first UWB tag and the second robot at the earlier timestamp and at the current timestamp.

It will be appreciated that step 903 further comprises obtaining rotating tag offset values of the second UWB tag with respect to the second robot at the earlier timestamp and at the current timestamp, respectively. In such case, calculating the relative position of the first robot with respect to the second robot at the current timestamp is further according to the rotating tag offset value of the second UWB tag with respect to the second robot.

In some embodiments for example as shown in FIG. 9, calculating the relative position of the first robot with respect to the second robot at the current timestamp comprises:
Step 904: calculating a relative location of the first UWB tag with respect to the second UWB tag at the earlier timestamp according to: the estimate of the relative position of the first robot with respect to the second robot at the earlier timestamp, the rotating tag offset value of the first UWB tag with respect to the first robot at the earlier timestamp, and the rotating tag offset value of the second UWB tag with respect to the second robot at the earlier timestamp;
Step 907: calculating a relative velocity value between the first robot and the second robot at the earlier timestamp based on the velocity value of the first robot at the earlier timestamp and the velocity value of the second robot at the earlier timestamp;
Step 908: calculating a relative rotation velocity value of the first UWB tag with respect to the first robot at the earlier timestamp according to the rotating tag offset value of the first UWB tag with respect to the first robot at the earlier timestamp and the current timestamp; and calculating relative rotation velocity value of the second UWB tag with respect to the second robot at the earlier timestamp according to the rotating tag offset value of the second UWB tag with respect to the second robot at the earlier timestamp and the current timestamp;
Step 909: calculating a relative displacement value of the first UWB tag with respect to the second UWB tag at the earlier timestamp according to the relative velocity value between the first robot and the second robot at the earlier timestamp, the relative rotation velocity value of the first UWB tag with respect to the first robot at the earlier timestamp, and the relative rotation velocity value of the second UWB tag with respect to the second robot at the earlier timestamp;
updating the relative position of the first robot with respect to the second robot at the current timestamp according to the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second UWB tag at the earlier timestamp.

In particular, updating the relative position of the first robot with respect to the second robot at the current timestamp comprises:
Step 912: updating estimation error at the current timestamp according to said distance value between the first UWB tag and the second UWB tag at the earlier timestamp and at the current timestamp, the relative displacement value of the first UWB tag with respect to the second UWB tag at the earlier timestamp, and the estimate of the relative position of the first UWB tag with respect to the second UWB tag at the earlier timestamp; and
Step 913: generating the relative position of the first robot with respect to the second robot at the current timestamp according to: the estimation error at the current timestamp, the relative location of the first UWB tag with respect to the second UWB tag at the earlier timestamp, the relative velocity value between the first robot and the second robot at the earlier timestamp, and the relative displacement value of the first UWB tag with respect to the second UWB tag at the earlier timestamp.

To be more specific, the algorithm 900 can be deployed on a first leader robot 0ₚ to estimate the relative location of a second leader robot 0_{q}, or on the first leader robot 0_{q} to estimate the relative location of the second leader robot 0ₚ.

In step 901, the initialization of algorithm 900 is illustrated, the initial estimation \hat{x}₀_{ₚ}_{⁰}_{_{q}}[0], the forgetting factor γ∈(0,1), the positive definite weight matrix P[0], and the sampling time ΔT need to be set. Moreover, the initial offset ρₚ[0] and initial distance

$${d}_{{u}_{{0}_{p}} {u}_{{0}_{q}}} [ 0 ]$$

should be received from sensors. Then, the serial number of the timestamp is added in 902. In 903, the offset ρₚ[k] and ρ_{q}[k] should be obtained from sensors.

Based on the offset at the previous timestamp, the estimation of the rotating tag u₀_{ₚ} with respect to the rotating tag u₀_{_{q}} can be obtained by the equation (8) in 904, that is:

$${\hat{x}}_{{u}_{{0}_{p}} {u}_{{0}_{q}}} [ k - 1 ] = {\hat{x}}_{{0}_{p} {0}_{q}} [ k - 1 ] - {ρ}_{p} [ k - 1 ] - {ρ}_{q} [ k - 1 ] \qquad ( 8 )$$

In steps 905 and 906, the velocities of the leader robot 0ₚ and the follower robot iₚ are obtained separately.

Then, the relative velocity between the two robots is obtained in step 907 according to equation (9), that is:

$${v}_{{0}_{p} {0}_{q}} [ k - 1 ] = {v}_{{0}_{p}} [ k - 1 ] - {v}_{{0}_{p}} [ k - 1 ] \qquad ( 9 )$$

The relative rotating velocity is obtained according to equation (10) in step 908, that is:

$${v}_{{ρ}_{p}} [ k - 1 ] = \frac{1}{Δ T} ( {ρ}_{p} [ k ] - {ρ}_{p} [ k - 1 ] ) \qquad ( 10 )$$

$${v}_{{ρ}_{q}} [ k - 1 ] = \frac{1}{Δ T} ( {ρ}_{q} [ k ] - {ρ}_{q} [ k - 1 ] )$$

Thus, the relative displacement of UWB tags between the last timestamp and the present timestamp,

$${η}_{{u}_{{0}_{p}} {u}_{{u}_{q}}} [ k - 1 ] ,$$

can be obtained by the equation (11) in step 909, that is:

$${η}_{{u}_{{0}_{p}} {u}_{{u}_{q}}} [ k - 1 ] = ( {v}_{{0}_{p} {0}_{q}} [ k - 1 ] + {v}_{{ρ}_{p}} [ k - 1 ] - {v}_{{ρ}_{q}} [ k - 1 ] ) Δ T \qquad ( 11 )$$

By the equation (12) in step 910, the weight matrix is updated, that is:

$$P [ k ] = \frac{1}{γ} ( I - \frac{P [ k - 1 ] {η}_{{u}_{{0}_{p}} {u}_{{0}_{p}}} [ k - 1 ] {η}_{{u}_{{0}_{p}} {u}_{{0}_{q}}}^{T} [ k - 1 ]}{γ + {η}_{{u}_{{0}_{p}} {u}_{{0}_{p}}}^{′} [ k - 1 ] P [ k - 1 ] {η}_{{u}_{{0}_{p}} {u}_{{0}_{p}}} [ k - 1 ]} ) P [ k - 1 ] \qquad ( 12 )$$

After receiving the distance information from the UWB tag in step 911, the estimation error ϵ[k] can be calculated in 912, that is:

$$ϵ [ k ] = \frac{1}{2} ( {d}_{{u}_{{0}_{p}} {u}_{{0}_{q}}}^{2} [ k ] - {d}_{{u}_{{0}_{p}} {u}_{{0}_{q}}}^{2} [ k - 1 ] - {‖ {η}_{{u}_{{0}_{p}} {u}_{{0}_{q}}} [ k - 1 ] ‖}^{2} ) - {η}_{{u}_{{0}_{p}} {u}_{{0}_{q}}}^{T} [ k - 1 ] {\hat{x}}_{{u}_{{0}_{p}} {u}_{{0}_{q}}} [ k - 1 ] \qquad ( 13 )$$

In step 913, the estimation of relative location between leader robot 0ₚ and follower robot iₚ can be calculated according to equation (14).

$${\hat{x}}_{{0}_{p} {0}_{q}} [ k ] = {\hat{x}}_{{0}_{p} {0}_{q}} [ k - 1 ] + {v}_{{0}_{p} {0}_{q}} [ k - 1 ] Δ T + P [ k ] {η}_{{u}_{{0}_{p}} {u}_{{0}_{q}}} [ k - 1 ] ϵ [ k ] ) \qquad ( 14 )$$

In step 914, the estimation is returned. It will be appreciated that the goal of this method is to give \hat{x}₀_{ₚ}_{⁰}_{_{q}}[k] by algorithms such that lim_{k→∞}∥\hat{x}₀_{ₚ}_{⁰}_{_{q}}[k]−x₀_{ₚ}_{⁰}_{_{q}}[k]∥=0 holds.

In general, the configuration of the second algorithm 900 is based on the same principles and framework as the first algorithm 700. However, the second algorithm 900 serves a different purpose than the first algorithm 700. While the first algorithm 700 is employed for localization between one rotating tag and one fixed tag, the second algorithm 900 is intended for localization between two rotating tags. Compared to the first algorithm 700, the steps involved in the second algorithm 900 are similar, except for two distinct computation steps, namely, steps 904 and 704, as well as steps 909 and 709, which differ between the two algorithms. It will be appreciated that these steps are utilized to calculate the last relative location between the tags as well as the relative displacement between two tags, respectively. The reason for the differences between the first algorithm 700 and the second algorithm 900 mainly stems from the fact that only one tag rotates in the first algorithm 700, while in the second algorithm, both tags rotate or move in a circular path about their respective centres of rotation.

The graphical representation depicted in FIG. 10B shows the correlation between the convergence rate of the proposed algorithm 700 and 900 and the length of the rod. As shown in FIG. 10A, to effectively demonstrate this impact, several rod lengths with significant differences were deliberately selected for analysis, specifically 0.2 m, 0.35 m, and 0.5 m. Notwithstanding the difference in height along the z-axis, it does not appear to have an impact on the convergence of the algorithm 700 as can be seen in FIG. 10B. As the rod length increases, the convergence rate accelerates, with the 0.5 m rod exhibiting the fastest convergence rate compared to the 0.35 m and 0.2 m rods.

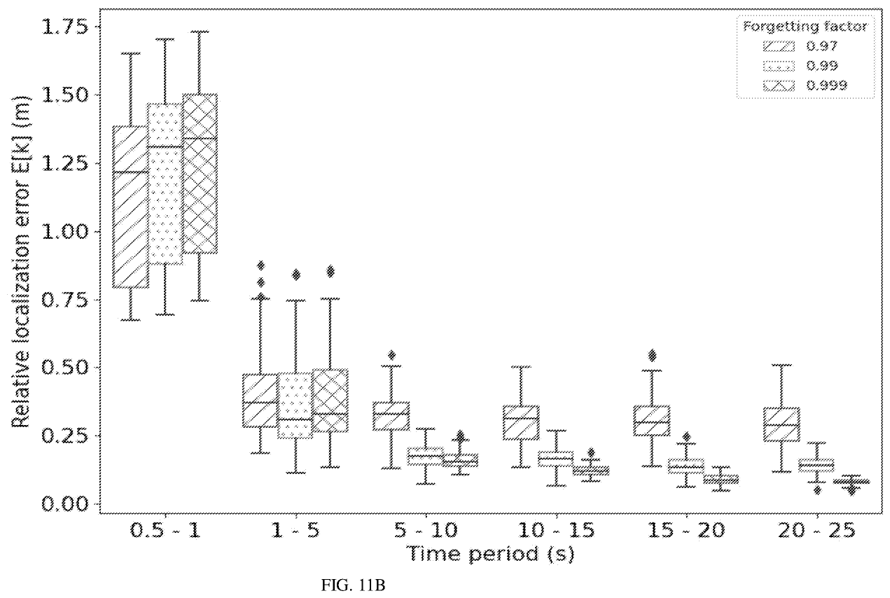

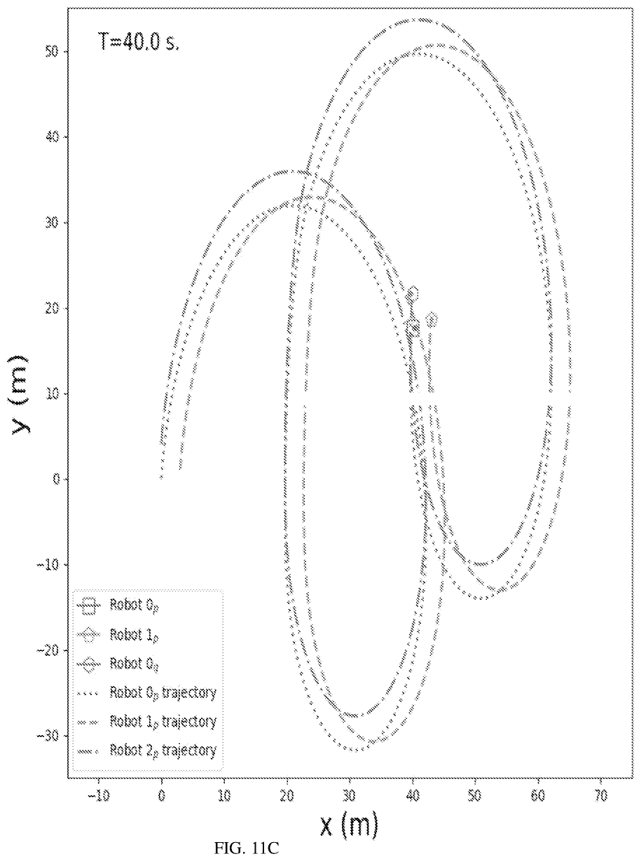

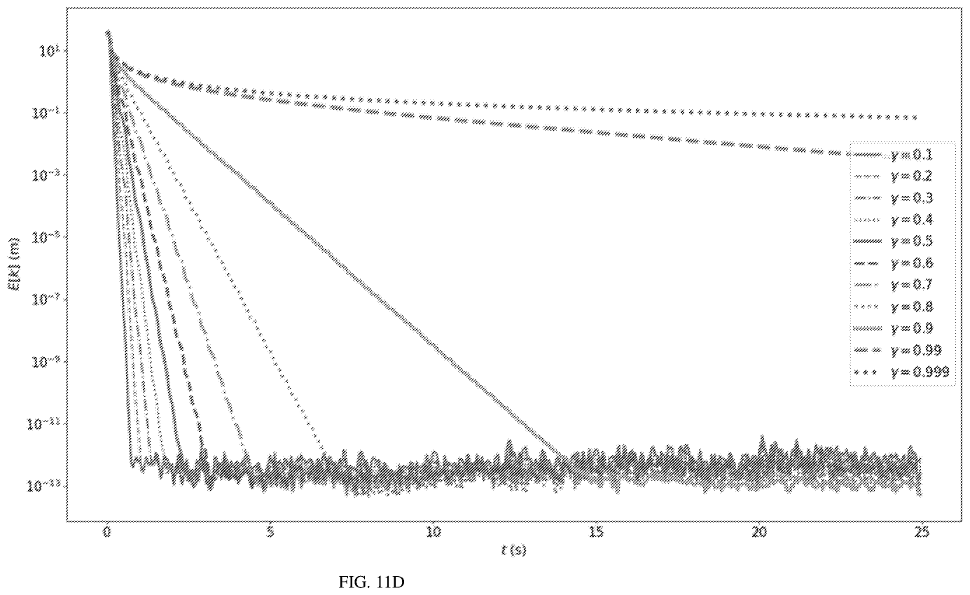

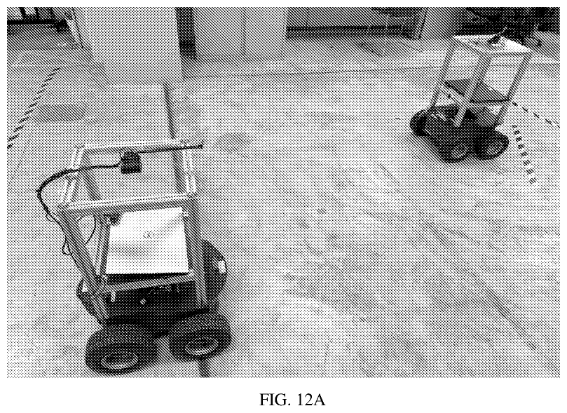

FIG. 11A shows the impact of various forgetting factors on the algorithmic error. Furthermore, FIG. 11B summarizes the magnitude of the algorithmic error for different forgetting factors using a box plot. Based on the results, it can be inferred that an increase in the forgetting factor leads to a gradual decrease in the convergence rate, however, it also leads to an improvement in the final localization accuracy, and a reduction in the variance of the error. This indicates an enhanced resistance to noise. FIG. 11C displays an alternative simulated trajectory, for which three different levels of noise were tested, and the results are summarized in Table 1 below.

TABLE 1

| Comparison of | | $\text{?} ( m )$ | | $\text{?} ( m )$ | | $\text{?} ( m )$ | | $\text{?} ( m )$ | |
|---|---|---|---|---|---|---|---|---|---|
| different noise levels | | RMS | SD | RMS | SD | RMS | SD | RMS | SD |
| Noise level | 0 s-5 s | 4.168 | 4.168 | .5190 | .4739 | 1.444 | 1.442 | .5151 | .5122 |
| ±0.05 m | 5 s-20 s | .0273 | .0117 | .0378 | .0116 | .0215 | .0054 | .0114 | .0103 |
| | 20 s-40 s | .0163 | .0124 | .0244 | .0106 | .0147 | .0043 | .0055 | .0023 |
| Noise level | 0 s-5 s | 9.608 | 9.598 | .7697 | .7662 | 6.046 | 6.042 | 1.625 | 1.610 |
| ±0.1 m | 5 s-20 s | .0794 | .0361 | .0325 | .0272 | .0232 | .0230 | .0184 | .0113 |
| | 20 s-40 s | .0361 | .0127 | .0490 | .0189 | .0250 | .0099 | .0092 | .0086 |
| Noise level | 0 s-5 s | 7.637 | 7.624 | 1.877 | 1.674 | 9.008 | 9.007 | 2.114 | 2.108 |
| ±0.2 m | 5 s-20 s | .1417 | .1050 | .3419 | .1322 | .0318 | .0288 | .0258 | .0187 |
| | 20 s-40 s | .0863 | .0769 | .0517 | .0487 | .0518 | .0119 | .0144 | .0143 |

$\text{?} \text{indicates text missing or illegible when filed}$

As the noise level increases, both the mean and variance of the estimation error increase. Nevertheless, the error level remains considerably lower than the noise level. Different forgetting factors are tried, and in FIG. 11D, the convergence rate of the algorithm decreases as the forgetting factor tends to one. The error converges to 10⁻¹² and starts to fluctuate, mainly due to the accuracy of the float number.

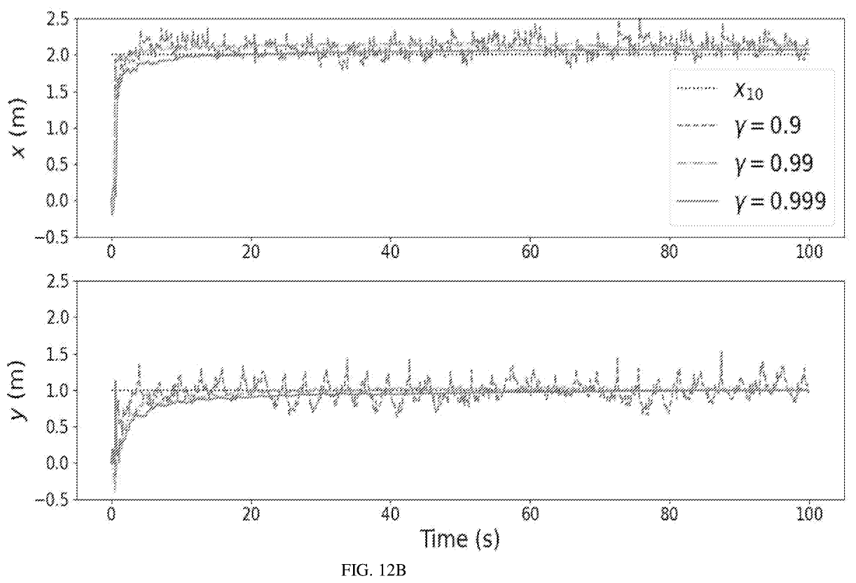

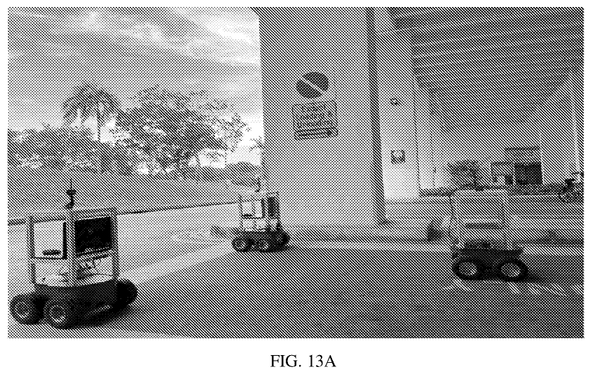

FIG. 12A and FIG. 12B show the experiment results of the present method in a stationary case. As shown in FIG. 12A, two robots remain stationary. The results in FIG. 12B show that as the forgetting factor increases, the convergence rate becomes slower, but the resistance to noise is enhanced.

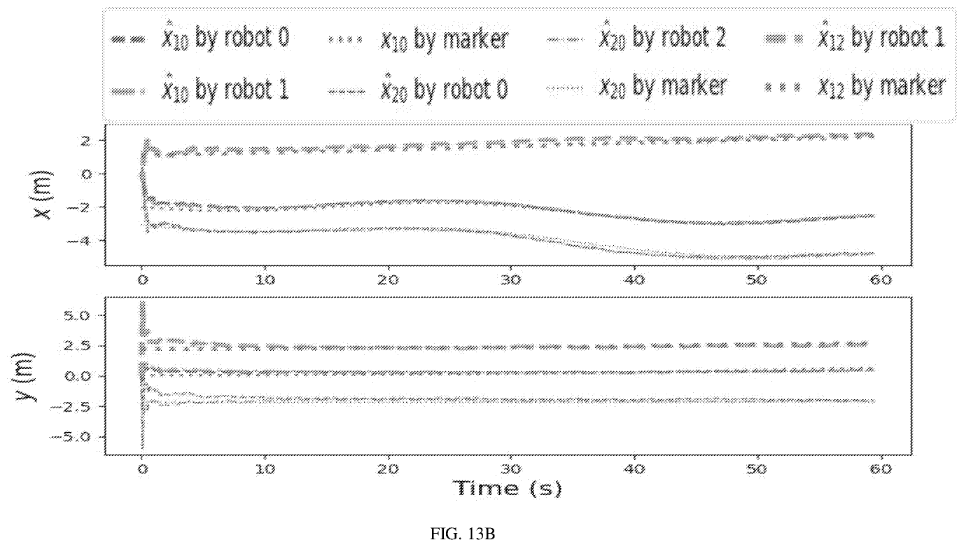

FIG. 13A and FIG. 13B show the experiment results of the present method in the relative motion case. Experiments were conducted in an outdoor environment as shown in FIG. 13A. The results of FIG. 13B show that the proposed method is still valid in the case of relative motion.

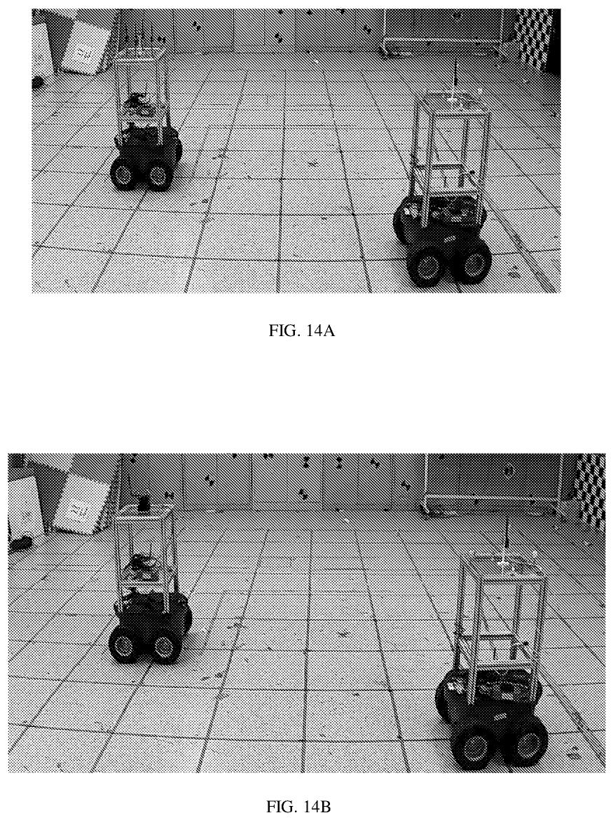

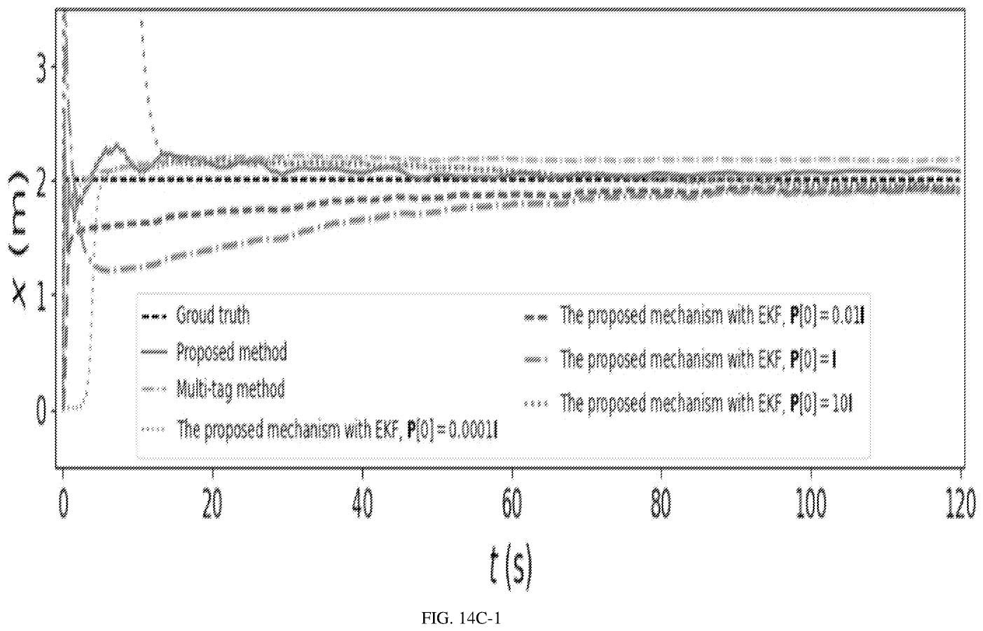

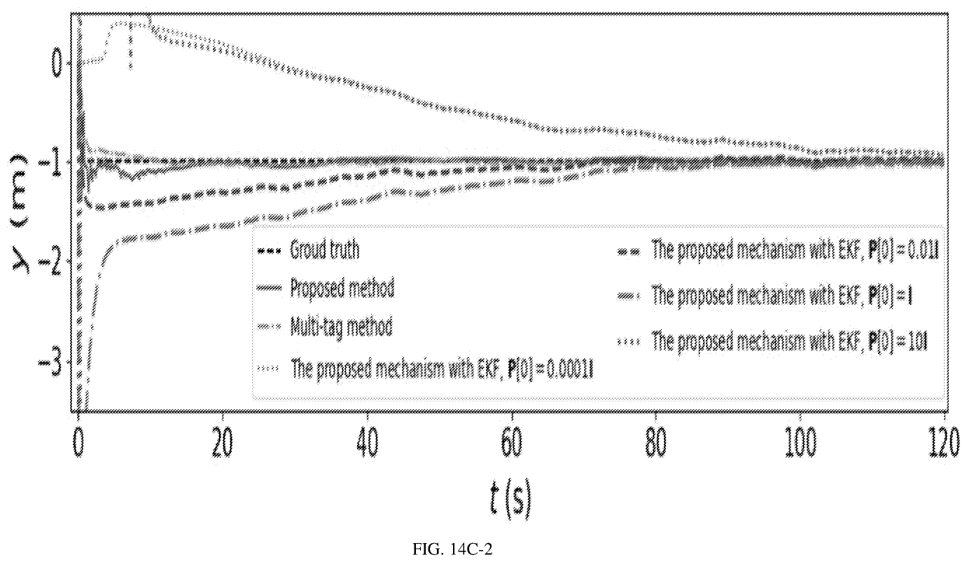

FIG. 14A illustrates a multi-tag configuration used for comparison with the proposed approach. Four tags are fixedly installed on a circular perimeter with a radius of 0.1 m, centered at the base link or geometric centre of the robot. On the other hand, FIG. 14B illustrates the proposed rotating tag configuration, in which the tag is displaced from the motor by using a rod having a length of 0.1 m. The data obtained from the experimental set-up shown in FIG. 14B tests both the proposed algorithm and the extended Kalman filter (EKF) algorithm, with varying initial weight P[0]. The results of the multi-tag configuration, the proposed approach, and the rotating mechanical structure combined with EKF algorithm are summarized in FIGS. 14C-1 and 14C-2. The outcomes of the experiment reveal that in scenarios involving small robots, the proposed localization scheme surpasses the multi-tag scheme, and the proposed algorithm is also more efficient than the EKF algorithm.

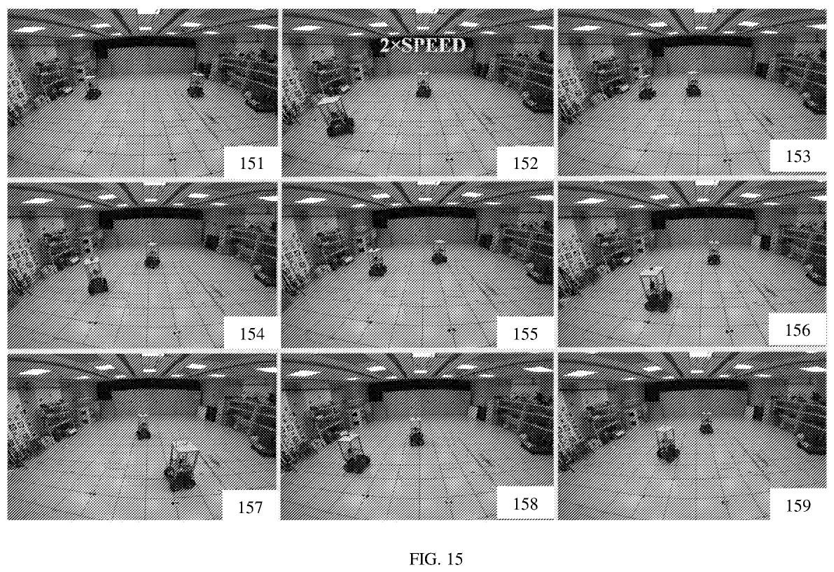

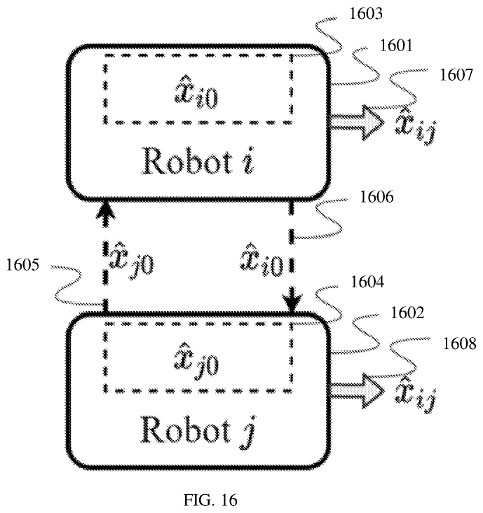

The proposed algorithm was further tested under nine distinct scenarios as shown in FIG. 15, utilizing rotating tags affixed to a rod length of 0.25 m. The algorithm 700, which pertains to relative localization within clusters, was assessed in the first five scenarios 151-155. During these trials, a leader robot 0₁ was outfitted with a rotating tag configured to rotate or move in a circular path about a centre of rotation, while a follower robot 1₁ possessed a fixed tag. In scenario 151, both robots remained stationary, while in scenarios 152 and 153, one of the robots traversed a 4 m×4 m square, while the other robot rotated at the centre of the square. In scenarios 154 and 155, both robots navigated the field in a random pattern through manual remote control. Furthermore, the algorithm 900 was evaluated between the leader robots of clusters 1 and 2 in four different scenarios 156-159 shown in FIG. 15, where leader robots 0₁ and 0₂ were each equipped with a rotating tag. In scenario 156, both leader robots 0₁ and 0₂ remained immobile, while in scenario 157 one of them moved according to the square, and the other rotated at the centre of the square. In scenarios 158 and 159, both leader robots 0₁ and 0₂ moved in a random fashion. Additionally, in scenarios 156-159, first leader robot 0₁'s tag rotated clockwise at 30 RPM, while in scenarios 156 and 157 second leader robot 0₂'s tag rotated counter clockwise at 30 RPM, and in scenarios 158 and 159 second leader robot 0₂'s tag rotated counter clockwise at 60 RPM.

Table 2 below summarizes the results obtained from the tests conducted under the nine different scenarios described above with reference to FIG. 15.

TABLE 2

| | $RMS ( \text{?} ) [ m ]$ | | | $SD ( \text{?} ) [ m ]$ | | | $RMS ( \text{?} ) [ m ]$ | | | $SD ( \text{?} ) [ m ]$ | | |
|---|---|---|---|---|---|---|---|---|---|---|---|---|
| # | R1 | R2 | R3 | R1 | R2 | R3 | R1 | R2 | R3 | R1 | R2 | R3 |
| E1 | 0.1330 | 0.0211 | 0.0599 | 0.0058 | 0.0016 | 0.0029 | 0.0336 | 0.0289 | 0.0145 | 0.0060 | 0.0016 | 0.0110 |
| E2 | 0.3726 | 0.3034 | 0.1278 | 0.2694 | 0.2642 | 0.0265 | 0.3590 | 0.3203 | 0.0729 | 0.2783 | 0.2782 | 0.0258 |
| E3 | 0.3280 | 0.2357 | 0.2074 | 0.2385 | 0.2324 | 0.0569 | 0.2517 | 0.2212 | 0.0736 | 0.2479 | 0.2004 | 0.0295 |
| E4 | 0.2932 | 0.1768 | 0.1089 | 0.2741 | 0.1176 | 0.0901 | 0.1481 | 0.1255 | 0.0707 | 0.1471 | 0.1255 | 0.0498 |
| E5 | 0.3552 | 0.2577 | 0.1139 | 0.3006 | 0.2407 | 0.0652 | 0.2396 | 0.2288 | 0.1623 | 0.2377 | 0.2288 | 0.0565 |
| | $RMS ( \text{?} ) [ m ]$ | | | $SD ( \text{?} ) [ m ]$ | | | $RMS ( \text{?} ) [ m ]$ | | | $SD ( \text{?} ) [ m ]$ | | |
| E6 | 0.2485 | 0.0343 | 0.1188 | 0.2332 | 0.0064 | 0.0261 | 0.0815 | 0.0174 | 0.0668 | 0.0661 | 0.0078 | 0.0388 |
| E7 | 0.3864 | 0.3511 | 0.0773 | 0.3773 | 0.3509 | 0.0703 | 0.3385 | 0.2997 | 0.1146 | 0.3380 | 0.2994 | 0.1121 |
| E8 | 0.3641 | 0.3541 | 0.1007 | 0.3025 | 0.2790 | 0.0769 | 0.2601 | 0.2275 | 0.1735 | 0.2397 | 0.2268 | 0.1327 |
| E9 | 0.3345 | 0.2627 | 0.1709 | 0.2737 | 0.2328 | 0.1707 | 0.2416 | 0.1960 | 0.1615 | 0.2095 | 0.1113 | 0.1473 |

$\text{?} \text{indicates text missing or illegible when filed}$

The data in column R1 was acquired solely from the data provided by the onboard sensors. In order to elucidate the impacts of the noise in the distance information furnished by the UWB, and the noise in the velocity information provided by the wheel encoder, we calculated the distance based on the ground truth supplied by Vicon and replaced the UWB data with it. The estimation results were recorded in columnR2. Furthermore, the velocity information based on Vicon was also calculated, and replaced the data supplied by the wheel encoder, with the results recorded in column R3.

In some embodiments, the method 700/900 further comprises estimating a relative position of the second robot (i.e. the follower robot or the leader robot 0_{q} in another cluster) with respect to a third robot according to the estimate of the relative position of the first robot (i.e., the first leader robot 0ₚ) with respect to the second robot and an estimate of the relative position of the first robot with respect to the third robot. Appreciably, the third robot similarly has a UWB tag provided thereon.

FIG. 16 is a flowchart illustrating details of required information exchange for relative localization between follower robots i (1601) and j (1602) which are within the same cluster of a first leader robot (0). To describe the relative localization method between the follower robots, the relative localization between the robots i (1601) and j (1602) is used as an example. For follower robot i (1601), based on the estimation \hat{x}ᵢ₀ (1603) obtained by the first algorithm 700 and the estimation \hat{x}ⱼ₀ (1605) obtained from robot j (1602) via Wi-Fi, the estimation \hat{x}ᵢⱼ (1607) can be obtained by a third algorithm 1700 illustrated in FIG. 17. For follower robot j (1602), based on the estimation \hat{x}ⱼ₀ (1604) obtained by the first algorithm 700 and the estimation \hat{x}ᵢ₀ (1606) obtained from robot i via Wi-Fi, the estimation \hat{x}ᵢⱼ (1608) can be obtained by the third algorithm 1700.

FIG. 17 depicts the flowchart to illustrate details of how to calculate the relative location between follower robots. Take the example of follower robot i estimating the relative location of follower robot j. Via the first algorithm 700, follower robot i can get the estimation \hat{x}ᵢ₀ in 1701, and in 1702, the estimation \hat{x}ⱼ₀ can be obtained from follower robot j via Wi-Fi. Thus, the relative location between follower robots \hat{x}ᵢⱼ can be obtained by the equation xᵢ_{ⱼ}[k]=xⱼ[k]−xⱼ[k] in 1703. In 1704, the timestamp k is updated.

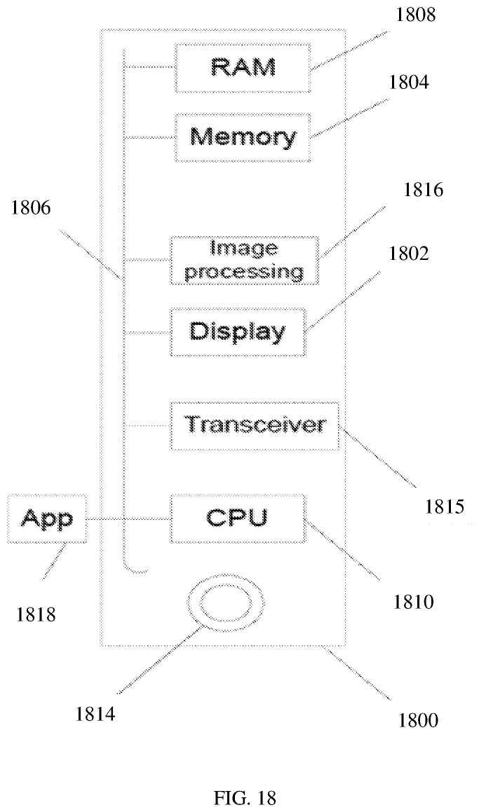

The present disclosure also relates to a system for estimating a relative position of a first robot with respect to a second robot at a current timestamp, wherein a first ultra-wideband (UWB) tag is installed on the first robot and configured to rotate or move in a circular path about a centre of rotation on the first robot and a second UWB tag is installed on the second robot. FIG. 18 shows an exemplary embodiment of a system 1800 comprising the program for processing methods 700/900 shown in FIG. 7 and FIG. 9. The system 1800 comprises:
a data processor (comprising N processing components 1810);
a memory 1804 coupled with the data processor; and
a program (not shown) stored in the memory 1804, the program including instructions capable of being executed by the data processor, wherein the program is configured to:
receive an estimate of the relative position of the first robot with respect to the second robot calculated at an earlier timestamp;
obtain rotating tag offset values of the first UWB tag with respect to the first robot at the earlier timestamp and at the current timestamp;
obtain a velocity value of the first robot at the earlier timestamp;
obtain a velocity value of the second robot at the earlier timestamp;
obtain distance values between the first UWB tag and the second UWB tag at the earlier timestamp and at the current timestamp; and
obtain the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

The system 1800 (such as a mobile device installed on the leader/follower robot) may be a handheld computer device such as one manufactured by Apple™, LG™, HTC™, Research In Motion™, Samsung™, Huawei™, Asus™, or Motorola™. The mobile device 1800 may also include a mobile computer such as a tablet computer, and wearable digital devices like smartwatches. As shown, the device 1800 may include the following components in electronic communication via a bus 1806:
1. a display 1802;
2. non-volatile memory 1804;
3. random access memory (“RAM”) 1808;
4. N processing components 1810;
5. a transceiver component 1815 that includes N transceivers;
6. image processing components 1816; and
7. user controls 1814.

Although the components depicted in FIG. 18 represent physical components, FIG. 18 is not intended to be a hardware diagram; thus, many of the components depicted in FIG. 18 may be realized by common constructs or distributed among additional physical components. Moreover, it is certainly contemplated that other existing and yet-to-be developed physical components and architectures may be utilized to implement the functional components described with reference to FIG. 18.

The display 1802 generally operates to provide a presentation of content to a user and may be realized by any of a variety of displays (e.g., CRT, LCD, HDMI, micro-projector and OLED displays). And in general, the non-volatile memory 1804 functions to store (e.g., persistently store) data and executable code including code that is associated with the functional components of a browser component and a digital wallet application (App) or optional merchant app 1818. In some embodiments, for example, the non-volatile memory 1804 includes bootloader code, modem software, operating system code, file system code, and code to facilitate the implementation of one or more portions of the digital wallet App 1818 or merchant App 1818 as well as other components well known to those of ordinary skill in the art that are not depicted for simplicity.

In many implementations, the non-volatile memory 1804 is realized by flash memory (e.g., NAND or ONENAND memory), but it is certainly contemplated that other memory types may be utilized as well. Although it may be possible to execute the code from the non-volatile memory 1804, the executable code in the non-volatile memory 1804 is typically loaded into RAM 1808 and executed by one or more of the N processing components 1810.

The N processing components 1810 in connection with RAM 1808 generally operate to execute the instructions stored in non-volatile memory 1804 to effectuate the functional components. As one of ordinarily skill in the art will appreciate, the N processing components 1810 may include a video processor, modem processor, DSP, graphics processing unit (GPU), and other processing components.

The transceiver component 1815 includes N transceiver chains, which may be used for communicating with external devices via wireless networks. Each of the N transceiver chains may represent a transceiver associated with a particular communication scheme. In the present disclosure, the transceiver component 1815 can be installed on the leader/follower robots for exchanging information with other robots. For example, each transceiver may correspond to protocols that are specific to local area networks, cellular networks (e.g., a CDMA network, a GPRS network, a UMTS networks), and other types of communication networks.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of estimating a relative position of a first robot with respect to a second robot at a current timestamp, wherein a first ultra-wideband (UWB) tag is installed on the first robot, the first UWB tag being a rotating tag configured to move in a circular path about a centre of rotation on the first robot, the second robot having a second UWB tag installed thereon, the method comprising:
receiving an estimate of the relative position of the first robot with respect to the second robot calculated at an earlier timestamp;
obtaining rotating tag offset values of the first UWB tag with respect to the first robot at the earlier timestamp and at the current timestamp;
obtaining a velocity value of the first robot at the earlier timestamp;
obtaining a velocity value of the second robot at the earlier timestamp;
obtaining distance values between the first UWB tag and the second UWB tag at the earlier timestamp and at the current timestamp; and
calculating the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

2. The method of claim 1, wherein the second UWB tag is immovably fixed to the second robot, wherein the first robot is configured to transmit to the second robot the velocity value of the first robot and the rotating tag offset value of the first UWB tag with respect to the first robot, wherein the second robot is configured to transmit to the first robot the velocity value of the second robot.

3. The method of claim 2, wherein calculating the relative position of the first robot with respect to the second robot at the current timestamp comprises:
calculating a relative position of the first UWB tag with respect to the second robot at the earlier timestamp based on the estimate of the relative position of the first robot with respect to the second robot at the earlier timestamp and the rotating tag offset value of the first UWB tag with respect to the first robot at the earlier timestamp;
calculating a relative velocity value between the first robot and the second robot at the earlier timestamp based on the velocity value of the first robot at the earlier timestamp and the velocity value of the second robot at the earlier timestamp;
calculating a relative rotation velocity value of the first UWB tag with respect to the first robot at the earlier timestamp according to the rotating tag offset value of the first UWB tag with respect to the first robot at the earlier timestamp and the current timestamp;
calculating a relative displacement value of the first UWB tag with respect to the second robot at the earlier timestamp according to: the relative velocity value between the first robot and the second robot at the earlier timestamp and the relative rotation velocity value of the first UWB tag with respect to the first robot at the earlier timestamp; and
updating the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second robot at the earlier timestamp.

4. The method of claim 3, wherein updating the relative position of the first robot with respect to the second robot at the current timestamp comprises:
updating an estimation error at the current timestamp according to: the distance values between the first UWB tag and the second UWB tag at the earlier timestamp and at the current timestamp, the relative displacement value of the first UWB tag with respect to the second robot at the earlier timestamp, and the calculated relative location of the first UWB tag with respect to the second robot at the earlier timestamp; and
calculating the relative position of the first robot with respect to the second robot at the current timestamp according to: the estimation error at the current timestamp, the relative displacement value of the first UWB tag with respect to the second robot at the earlier timestamp, and the relative velocity value between the first robot and the second robot at the earlier timestamp.

5. The method of claim 1, wherein the second UWB tag is a rotating tag configured to move in a circular path about a centre of rotation on the second robot, the method further comprising:
obtaining rotating tag offset values of the second UWB tag with respect to the second robot at the earlier timestamp and at the current timestamp, respectively;
wherein calculating the relative position of the first robot with respect to the second robot at the current timestamp is further according to the rotating tag offset value of the second UWB tag with respect to the second robot.

6. The method of claim 5, wherein the first robot is configured to transmit to the second robot the velocity value of the first robot and the rotating tag offset value of the first UWB tag with respect to the first robot, wherein the second robot is configured to transmit to the first robot the velocity value of the second robot and the rotating tag offset value of the second UWB tag with respect to the second robot.

7. The method of claim 5, wherein calculating the relative position of the first robot with respect to the second robot at the current timestamp comprises:
calculating a relative location of the first UWB tag with respect to the second UWB tag at the earlier timestamp according to: the estimate of the relative position of the first robot with respect to the second robot at the earlier timestamp, the rotating tag offset value of the first UWB tag with respect to the first robot at the earlier timestamp, and the rotating tag offset value of the second UWB tag with respect to the second robot at the earlier timestamp;
calculating a relative velocity value between the first robot and the second robot at the earlier timestamp based on the velocity value of the first robot at the earlier timestamp and the velocity value of the second robot at the earlier timestamp;
calculating a relative rotation velocity value of the first UWB tag with respect to the first robot at the earlier timestamp according to: the rotating tag offset values of the first UWB tag with respect to the first robot at the earlier timestamp and at the current timestamp;
calculating a relative rotation velocity value of the second UWB tag with respect to the second robot at the earlier timestamp according to: the rotating tag offset values of the second UWB tag with respect to the second robot at the earlier timestamp and at the current timestamp;
calculating a relative displacement value of the first UWB tag with respect to the second UWB tag at the earlier timestamp according to: the relative velocity value between the first robot and the second robot at the earlier timestamp, the relative rotation velocity value of the first UWB tag with respect to the first robot at the earlier timestamp, and the relative rotation velocity value of the second UWB tag with respect to the second robot at the earlier timestamp;
updating the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second UWB tag at the earlier timestamp.

8. The method of claim 7, wherein updating the relative position of the first robot with respect to the second robot at the current timestamp comprises:
updating estimation error at the current timestamp according to the distance values between the first UWB tag and the second UWB tag at the earlier timestamp and at the current timestamp, the relative displacement value of the first UWB tag with respect to the second UWB tag at the earlier timestamp, and the estimate of the relative position of the first UWB tag with respect to the second UWB tag at the earlier timestamp; and
generating the relative position of the first robot with respect to the second robot at the current timestamp according to: the estimation error at the current timestamp, the relative location of the first UWB tag with respect to the second UWB tag at the earlier timestamp, the relative velocity value between the first robot and the second robot at the earlier timestamp, and the relative displacement value of the first UWB tag with respect to the second UWB tag at the earlier timestamp.

9. The method of claim 1, further comprising estimating a relative position of the second robot with respect to a third robot according to the estimate of the relative position of the first robot with respect to the second robot and an estimate of the relative position of the first robot with respect to the third robot, the third robot having a UWB tag installed thereon.

10. The method of claim 9, wherein the second robot is configured to transmit to the third robot the estimate of the relative position of the first robot with respect to the second robot, wherein the third robot is configured to transmit to the second robot the estimate of the relative position of the first robot with respect to the third robot.

11. A system for estimating a relative position of a first robot with respect to a second robot at a current timestamp, the first robot having a first ultra-wideband (UWB) tag installed thereon, the first UWB tag being a rotating tag configured to move in a circular path about a centre of rotation on the first robot, the second robot having a second UWB tag installed thereon, the system comprising:
a data processor;
a memory coupled with the data processor; and
a program stored in the memory, the program including instructions capable of being executed by the data processor,
wherein the program is configured to:
receive an estimate of the relative position of the first robot with respect to the second robot calculated at an earlier timestamp;
obtain rotating tag offset values of the first UWB tag with respect to the first robot at the earlier timestamp and at the current timestamp;
obtain a velocity value of the first robot at the earlier timestamp;
obtain a velocity value of the second robot at the earlier timestamp;
obtain distance values between the first UWB tag and the second UWB tag at the earlier timestamp and at the current timestamp; and
calculate the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

12. The system of claim 11, wherein the second UWB tag is immovably fixed to the second robot, wherein the first robot is configured to transmit to the second robot the velocity value of the first robot and the rotating tag offset value of the first UWB tag with respect to the first robot, wherein the second robot is configured to transmit to the first robot the velocity value of the second robot.

13. The system of claim 12, wherein to calculate the relative position of the first robot with respect to the second robot at the current timestamp, the program is configured to:
calculate a relative position of the first UWB tag with respect to the second robot at the earlier timestamp based on the estimate of the relative position of the first robot with respect to the second robot at the earlier timestamp and the rotating tag offset value of the first UWB tag with respect to the first robot at the earlier timestamp;
calculate a relative velocity value between the first robot and the second robot at the earlier timestamp based on the velocity value of the first robot at the earlier timestamp and the velocity value of the second robot at the earlier timestamp;
calculate a relative rotation velocity value of the first UWB tag with respect to the first robot at the earlier timestamp according to the rotating tag offset value of the first UWB tag with respect to the first robot at the earlier timestamp and the current timestamp;
calculate a relative displacement value of the first UWB tag with respect to the second robot at the earlier timestamp according to: the relative velocity value between the first robot and the second robot at the earlier timestamp and the relative rotation velocity value of the first UWB tag with respect to the first robot at the earlier timestamp; and
update the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second robot at the earlier timestamp.

14. The system of claim 13, wherein to update the relative position of the first robot with respect to the second robot at the current timestamp, the program is configured to:
update an estimation error at the current timestamp according to: the distance values between the first UWB tag and the second UWB tag at the earlier timestamp and at the current timestamp, the relative displacement value of the first UWB tag with respect to the second robot at the earlier timestamp, and the calculated relative location of the first UWB tag with respect to the second robot at the earlier timestamp; and
calculate the relative position of the first robot with respect to the second robot at the current timestamp according to: the estimation error at the current timestamp, the relative displacement value of the first UWB tag with respect to the second robot at the earlier timestamp, and the relative velocity value between the first robot and the second robot at the earlier timestamp.

15. The system of claim 14, wherein the second UWB tag is a rotating tag configured to move in a circular path about a centre of rotation on the second robot, wherein the program is further configured to:
obtain rotating tag offset values of the second UWB tag with respect to the second robot at the earlier timestamp and at the current timestamp, respectively; and
calculate the relative position of the first robot with respect to the second robot at the current timestamp according to the rotating tag offset value of the second UWB tag with respect to the second robot.

16. The system of claim 15, wherein the first robot is configured to transmit to the second robot the velocity value of the first robot and the rotating tag offset value of the first UWB tag with respect to the first robot, wherein the second robot is configured to transmit to the first robot the velocity value of the second robot and the rotating tag offset value of the second UWB tag with respect to the second robot.

17. The system of claim 15, wherein to calculate the relative position of the first robot with respect to the second robot at the current timestamp, the program is configured to:
calculate a relative location of the first UWB tag with respect to the second UWB tag at the earlier timestamp according to: the estimate of the relative position of the first robot with respect to the second robot at the earlier timestamp, the rotating tag offset value of the first UWB tag with respect to the first robot at the earlier timestamp, and the rotating tag offset value of the second UWB tag with respect to the second robot at the earlier timestamp;
calculate a relative velocity value between the first robot and the second robot at the earlier timestamp based on the velocity value of the first robot at the earlier timestamp and the velocity value of the second robot at the earlier timestamp;
calculate a relative rotation velocity value of the first UWB tag with respect to the first robot at the earlier timestamp according to: the rotating tag offset values of the first UWB tag with respect to the first robot at the earlier timestamp and at the current timestamp;
calculate a relative rotation velocity value of the second UWB tag with respect to the second robot at the earlier timestamp according to: the rotating tag offset values of the second UWB tag with respect to the second robot at the earlier timestamp and at the current timestamp;
calculate a relative displacement value of the first UWB tag with respect to the second UWB tag at the earlier timestamp according to: the relative velocity value between the first robot and the second robot at the earlier timestamp, the relative rotation velocity value of the first UWB tag with respect to the first robot at the earlier timestamp, and the relative rotation velocity value of the second UWB tag with respect to the second robot at the earlier timestamp;
update the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second UWB tag at the earlier timestamp.

18. The system of claim 17, wherein to update the relative position of the first robot with respect to the second robot at the current timestamp, the program is further configured to:
update estimation error at the current timestamp according to the distance values between the first UWB tag and the second UWB tag at the earlier timestamp and at the current timestamp, the relative displacement value of the first UWB tag with respect to the second UWB tag at the earlier timestamp, and the estimate of the relative position of the first UWB tag with respect to the second UWB tag at the earlier timestamp; and
generate the relative position of the first robot with respect to the second robot at the current timestamp according to: the estimation error at the current timestamp, the relative location of the first UWB tag with respect to the second UWB tag at the earlier timestamp, the relative velocity value between the first robot and the second robot at the earlier timestamp, and the relative displacement value of the first UWB tag with respect to the second UWB tag at the earlier timestamp.

19. The system of claim 11, wherein the program is further configured to estimate a relative position of the second robot with respect to a third robot according to: the estimate of the relative position of the first robot with respect to the second robot and an estimate of the relative position of the first robot with respect to the third robot, the third robot having a UWB tag installed thereon.

20. The system of claim 19, wherein the second robot is configured to transmit to the third robot the estimate of the relative position of the first robot with respect to the second robot, wherein the third robot is configured to transmit to the second robot the estimate of the relative position of the first robot with respect to the third robot.

21. A multi-robot system comprising:
a first robot having a first ultra-wideband (UWB) tag installed thereon, the first UWB tag being a rotating tag configured to move in a circular path about a centre of rotation on the first robot;
a second robot having a second UWB tag installed thereon;
a data processor;
a memory coupled with the data processor; and
a program stored in the memory, the program including instructions capable of being executed by the data processor, wherein the program is configured to estimate a relative position of a first robot with respect to a second robot at a current timestamp, the program being configured to:
receive an estimate of the relative position of the first robot with respect to the second robot calculated at an earlier timestamp;
obtain rotating tag offset values of the first UWB tag with respect to the first robot at the earlier timestamp and at the current timestamp;
obtain a velocity value of the first robot at the earlier timestamp;
obtain a velocity value of the second robot at the earlier timestamp;
obtain distance values between the first UWB tag and the second UWB tag at the earlier timestamp and at the current timestamp; and
calculate the relative position of the first robot with respect to the second robot at the current timestamp according to: the estimate of the relative position calculated at the earlier timestamp, the rotating tag offset values of the first UWB tag with respect to the first robot at the earlier timestamp and at the current timestamp, the velocity values of the first robot at the earlier timestamp, the velocity values of the second robot at the earlier timestamp, and the distance values between the first UWB tag and the second UWB tag at the earlier timestamp and at the current timestamp.

22. The multi-robot system of claim 21, wherein the second UWB tag is immovably fixed to the second robot, wherein the first robot is configured to transmit to the second robot the velocity value of the first robot and the rotating tag offset value of the first UWB tag with respect to the first robot, wherein the second robot is configured to transmit to the first robot the velocity value of the second robot.

23. The multi-robot system of claim 22, wherein to calculate the relative position of the first robot with respect to the second robot at the current timestamp, the program is configured to:
calculate a relative position of the first UWB tag with respect to the second robot at the earlier timestamp based on the estimate of the relative position of the first robot with respect to the second robot at the earlier timestamp and the rotating tag offset value of the first UWB tag with respect to the first robot at the earlier timestamp;
calculate a relative velocity value between the first robot and the second robot at the earlier timestamp based on the velocity value of the first robot at the earlier timestamp and the velocity value of the second robot at the earlier timestamp;
calculate a relative rotation velocity value of the first UWB tag with respect to the first robot at the earlier timestamp according to the rotating tag offset value of the first UWB tag with respect to the first robot at the earlier timestamp and the current timestamp;
calculate a relative displacement value of the first UWB tag with respect to the second robot at the earlier timestamp according to: the relative velocity value between the first robot and the second robot at the earlier timestamp and the relative rotation velocity value of the first UWB tag with respect to the first robot at the earlier timestamp; and
update the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second robot at the earlier timestamp.

24. The multi-robot system of claim 23, wherein to update the relative position of the first robot with respect to the second robot at the current timestamp, the program is further configured to:
update an estimation error at the current timestamp according to: the distance values between the first UWB tag and the second UWB tag at the earlier timestamp and at the current timestamp, the relative displacement value of the first UWB tag with respect to the second robot at the earlier timestamp, and the calculated relative location of the first UWB tag with respect to the second robot at the earlier timestamp; and
calculate the relative position of the first robot with respect to the second robot at the current timestamp according to: the estimation error at the current timestamp, the relative displacement value of the first UWB tag with respect to the second robot at the earlier timestamp, and the relative velocity value between the first robot and the second robot at the earlier timestamp.

25. The multi-robot system of claim 24, wherein the second UWB tag is a rotating tag configured to move in a circular path around a centre of rotation on the second robot, wherein the program is further configured to:
obtain rotating tag offset values of the second UWB tag with respect to the second robot at the earlier timestamp and at the current timestamp, respectively; and
calculate the relative position of the first robot with respect to the second robot at the current timestamp according to the rotating tag offset value of the second UWB tag with respect to the second robot.

26. The multi-robot system of claim 25, wherein the first robot is configured to transmit to the second robot the velocity value of the first robot and the rotating tag offset value of the first UWB tag with respect to the first robot, wherein the second robot is configured to transmit to the first robot the velocity value of the second robot and the rotating tag offset value of the second UWB tag with respect to the second robot.

27. The multi-robot system of claim 25, wherein to calculate the relative position of the first robot with respect to the second robot at the current timestamp, the program is configured to:
calculate a relative location of the first UWB tag with respect to the second UWB tag at the earlier timestamp according to: the estimate of the relative position of the first robot with respect to the second robot at the earlier timestamp, the rotating tag offset value of the first UWB tag with respect to the first robot at the earlier timestamp, and the rotating tag offset value of the second UWB tag with respect to the second robot at the earlier timestamp;
calculate a relative velocity value between the first robot and the second robot at the earlier timestamp based on the velocity value of the first robot at the earlier timestamp and the velocity value of the second robot at the earlier timestamp;
calculate a relative rotation velocity value of the first UWB tag with respect to the first robot at the earlier timestamp according to: the rotating tag offset values of the first UWB tag with respect to the first robot at the earlier timestamp and at the current timestamp;
calculate a relative rotation velocity value of the second UWB tag with respect to the second robot at the earlier timestamp according to: the rotating tag offset values of the second UWB tag with respect to the second robot at the earlier timestamp and at the current timestamp;
calculate a relative displacement value of the first UWB tag with respect to the second UWB tag at the earlier timestamp according to: the relative velocity value between the first robot and the second robot at the earlier timestamp, the relative rotation velocity value of the first UWB tag with respect to the first robot at the earlier timestamp, and the relative rotation velocity value of the second UWB tag with respect to the second robot at the earlier timestamp;
update the relative position of the first robot with respect to the second robot at the current timestamp according to: the estimate of the relative position of the first robot with respect to the second robot at the earlier timestamp, the relative velocity value between the first robot and the second robot at the earlier timestamp, the distance value between the first UWB tag and the second UWB tag at the earlier timestamp and the current timestamp, and the relative displacement value of the first UWB tag with respect to the second UWB tag at the earlier timestamp.

28. The multi-robot system of claim 27, wherein to update the relative position of the first robot with respect to the second robot at the current timestamp, the program is configured to:
update estimation error at the current timestamp according to the distance values between the first UWB tag and the second UWB tag at the earlier timestamp and at the current timestamp, the relative displacement value of the first UWB tag with respect to the second UWB tag at the earlier timestamp, and the estimate of the relative position of the first UWB tag with respect to the second UWB tag at the earlier timestamp; and
generate the relative position of the first robot with respect to the second robot at the current timestamp according to: the estimation error at the current timestamp, the relative location of the first UWB tag with respect to the second UWB tag at the earlier timestamp, the relative velocity value between the first robot and the second robot at the earlier timestamp, and the relative displacement value of the first UWB tag with respect to the second UWB tag at the earlier timestamp.

29. The multi-robot system of claim 21, further comprising a third robot, the third robot having a UWB tag installed thereon, wherein the program is further configured to estimate a relative position of the second robot with respect to the third robot according to: the estimate of the relative position of the first robot with respect to the second robot and an estimate of the relative position of the first robot with respect to the third robot.

30. The multi-robot system of claim 29, wherein the second robot is configured to transmit to the third robot the estimate of the relative position of the first robot with respect to the second robot, wherein the third robot is configured to transmit to the second robot the estimate of the relative position of the first robot with respect to the third robot.

31. The multi-robot system of claim 21, wherein a motor is provided on the robot at the centre of rotation and the first UWB tag is displaced at a fixed distance from the motor such that rotation of the motor moves the first UWB tag about the centre of rotation in the circular path.

32. The multi-robot system of claim 31, wherein the first UWB tag is provided at a first end of a rod, the first end being a free end, and a second end of the rod is attached to the motor.
